(19) United States
(12) Patent Application Publication
(10) Pub. No.: US 2026/0305608 A1
(43) Pub. Date: Oct. 8, 2026

(54) MIXTURE COMBINATIONS FOR CROP PROTECTION

(71) Applicant: ADAMA MAKHTESHIM LTD., Beer Sheva (IL)

(72) Inventors: Lior WALDMAN, Herzeliya (IL); Andrew HORSFIELD, Brisbane, Queensland (AU); Mariela FAURE MLYNSKI, Gedera (IL)

(73) Assignee: ADAMA MAKHTESHIM LTD., Beer Sheva (IL)

(21) Appl. No.: 19/482,056

(22) PCT Filed: May 8, 2024
(86) PCT No.: PCT/IL2024/050441

§ 371 Date: Nov. 6, 2025

Related U.S. Application Data
(60) Provisional application No. 63/464,640, filed on May 8, 2023.

(51) Int. Cl. A01N 37/44; A01N 33/26; A01N 43/40; A01N 43/80; A01N 65/40; A01P 7/04; A01P 21/00

(52) U.S. Cl. CPC A01N 37/44; A01N 33/26; A01N 43/40; A01N 43/80; A01N 65/40; A01P 7/04; A01P 21/00

(57) ABSTRACT

The present invention relates to effective combinations of active compounds comprising, Tau fluvalinate and at least one further active compound, and to methods of controlling pests comprising applying said combinations.

This application claims benefits of the US Provisional Application No. 63/464,640 filed on May 8, 2023; the entire content of which is incorporated by reference herein.

Throughout this application, various publications are cited. Disclosures of the documents and publications referred to herein are hereby incorporated in their entireties by references into this application.

### FIELD OF INVENTION

The present invention relates to mixture combinations of active compounds comprising, Tau-fluvalinate and at least one further crop protection chemical, and to methods of controlling pests comprising applying said combinations.

### BACKGROUND OF INVENTION

The vulnerability of crops to pests and fungi makes crop protection management one of the major components of the total crop production system. Various Insects and fungi along with the undesired weeds are very harmful to crop plants and can significantly reduce crop yields and qualities. Insecticides alone or in combination with fungicides and weedicides help minimize this damage by controlling threats to the crop. Many crop protection chemicals either of same class or of mixtures of different classes are commercially available for these purposes.

Combinations of insecticides or mixture of one or more insecticides with other crop protection chemical are typically used to broaden spectrum of control, to minimize the doses of chemicals used, to retard resistance development and to reduce the cost of the treatment through additive effect. Although many combinations of one insecticidal agent with one or more crop protection chemicals have been studied, a synergistic effect is rarely attained.

Practical agricultural experience has shown that the repeated and exclusive application of an individual active compound in the control of insect pests leads in many cases to a selection of those pests which have developed natural or adapted resistance against the active compound in question. Effective control of these pests with the active compound in question is then no longer possible.

Another difficulty in relation to the use of insecticides is that the repeated and exclusive application of an individual insecticidal compound leads in many cases to a rapid selection of pests which have developed natural or adapted resistance against the active compound in question. Therefore there is a need for crop protection chemicals that help prevent or overcome resistance. In order to reduce the risk of insect pests becoming resistant to certain active compounds, mixtures of different crop protection chemicals are nowadays conventionally employed for controlling insect pests. By combining judiciously active compounds having different mechanisms of action, it is possible to ensure successful control over a relatively long period of time.

Tau-fluvalinate, ((RS)-α-Cyano-3-phenoxybenzyl N-(2-chloro-α,α,α-trifluoro-p-tolyl)-D-valinate),

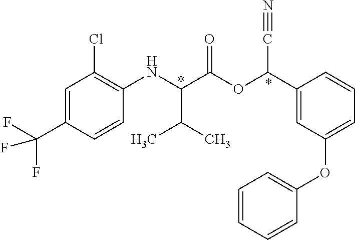 [SMILES: CC(C)C(Nc1ccc(C(F)(F)F)cc1Cl)C(=O)OC(C#N)c1cccc(Oc2ccccc2)c1]

is described in “The E-Pesticide Manual” (Version 5.0.1, 2010, 15th Edition, Editor: CDS Tomlin)) Entry number 423, and is an acaricide (e.g. a miticide), that is commonly used to control varroa mites in honey bee colonies, infestations that constitute a significant disease of such insects.

Active agent mixtures are described in the literature. However, the control over the pests does not always satisfy the needs of agriculture practice. Additionally, the efficacy of mixtures is not entirely satisfactory in cases of pest control and/or toxicological and/or environmental effects. Random pesticidal compositions and mixtures do not exert a satisfactory controlling effect in most of the cases, and therefore, there is an urgent need for development of new pesticidal mixtures with one more crop protection chemical having some satisfactory controlling effects.

It is an object of the present invention to provide mixtures and compositions of judiciously selected crop protection chemicals which, when applied at a reduced total amount of active compounds, have improved activity against the harmful pests. It is an object of the present invention to provide a broadened activity spectrum or a combination of knock-down activity with prolonged control. It is a further object of the present invention to provide mixtures and compositions which provide effective resistance management and insect pests control, at application rates which are as low as possible.

It is an endeavor of the present invention to find that mixtures comprising Tau fluvalinate and at least one further crop protection chemical are synergistically effective, being applied simultaneously, that is jointly or separately, or in succession, allows better control of insect pests than is possible with the individual compounds alone, providing synergistic results and solving at least one of the challenges in the prior art by reducing the dosage rate or enhancing the spectrum of activity or combining knock-down activity with prolonged control or facilitating resistance management.

In light of the above, there is endeavor in the present invention for an effective mixture combination of crop protection chemicals that exhibit synergistically enhanced action, a broader scope of activity and reduced cost of treatment.

### SUMMARY OF THE PRESENT INVENTION

We have reasonably found that the object as described above is as a whole or in part achieved by the combination of active compounds defined below.

The present invention relates to a mixture combination comprising, as active compounds:
i) Tau-fluvalinate; and
ii) at least one crop protection chemical compound II selected from the groups (1) to (37):
   (1) a synthetic pyrethroid selected from a group consisting of Gamma-cyhalothrin, Alpha-cypermethrin, Etofenprox and Tefluthrin,
   (2) a Nicotinic acetylcholine receptor (nAChR) competitive modulator selected from a group comprising Flupyradifurone, Flupyrimin, and Triflumezopyrim,
   (3) an Uncoupler of oxidative phosphorylation via disruption of proton gradient comprising Chlorfenapyr and Brochlorfenapyr,
   (4) a Ryanodine receptor modulator selected from a group comprising Tetrachlorantraniliprole and Thiotraniliprole,
   (5) a Nicotinic acetylcholine receptor channel blocker selected from a group comprising Bensultap, Cartap hydrochloride, Thiocyclam and Thisultap-sodium,
   (6) a Mitochondrial complex electron transport inhibitor (METI) selected from a group comprising Fenazaquin, Pyridaben, Pyrimidifen, Tebufenpyrad and Cyetpyrafen,
   (7) a meta-diamide insecticide selected from a group comprising Fluxametamide and Isocycloseram,
   (8) a broad-spectrum insect growth regulator selected from a group comprising Fenoxycarb,
   (9) a Glutamate-gated chloride channel (GluCl) allosteric modulator selected from a group comprising Milbemectin and Lepimectin,
   (10) a Voltage-dependent sodium channel Blocker selected from a group comprising Metaflumizone,
   (11) an Inhibitor of chitin biosynthesis affecting CHS1, selected from a group comprising Diflubenzuron, Flufenoxuron, Lufenuron, Teflubenzuron and Chlorfluazuron,
   (12) an Inhibitor of acetyl COA carboxylase selected from a group comprising Spidoxamat, Spirodiclofen and Spiromesifen,
   (13) an Entomopathogenic fungal agent comprising Beauveria spp, Metarhizium spp and Paecilomyces spp,
   (14) a Baculovirus comprising:
      Granuloviruses such as Cydia pomonella GV, Thaumatotibia leucotreta GV,
      Nucleoopolyhedrosisvirus such as Anticarsia gemmatalis MNPV and Helicoverpa armigera NPV,
   (15) a Mitochondrial complex III electron transport inhibitors—Qi site comprising Flometoquin,
   (16) a Chitin biosynthesis inhibitor (type 1) comprising Buprofezin,
   (17) an Ecdysone receptor agonist comprising Chromafenozide, Halofenozide, Methoxyfenozide and Tebufenozide,
   (18) a Mitochondrial complex III electron transport inhibitor (Qo site) comprising Acequinocyl, Fluacrypyrim and Hydramethylnon,
   (19) a Cyclotide insecticide and repellent comprising Clotoria Ternatea,
   (20) a Nicotinic acetylcholine receptor (nAChR) allosteric modulator (site II) comprising GS-omega/kappa HXTX-Hvla peptide,
   (21) a Calcium-activated potassium channel (KCa2) modulator comprising Acynonapyr,
   (22) an Insecticide synergist comprising N-octyl bicycloheptene dicarboximide (MGK-264), Piprotal, Propyl isome, Sesamex, Sesamolin and Sulfoxide,
   (23) a Fungicide selected from a group comprising Pydiflumetofen, Fluazinam, Fluxapyroxad, Difenoconazole, Tebuconazole, Fludioxonil, Azoxystrobin and Mancozeb,
   (24) a Neonicotinoid insecticide selected from a group comprising Cycloxaprid, Guadipyr and Imidaclothiz,
   (25) an Acaricide selected from a group comprising Cyflumetofen and Sila-Cyflumetofen,
   (26) a Diamide insecticide selected from a group comprising Cyproflanilide,
   (27) a Mesoionic insecticide selected from a group comprising Dicloromezotiaz and Fenmezoditiaz,
   (28) a Pyrazole carboxamide insecticide selected from a group comprising Dimpropyridaz, Tyclopyrazoflor, Fluchlordiniliprole,
   (29) a Sulfonamide nematicide selected from a group comprising Fluazaindolizine,
   (30) a Phenylpyrazole insecticide selected from a group comprising Flufiprole, Nicofluprole and Pyriprole,
   (31) a Fluorine containing insecticide selected from a group comprising Fluhexafon, Bistrifluron and Trifluenfuronate,
   (32) an Isoxazoline parasiticide selected from a group comprising Lotilaner,
   (33) an Indazole insecticide selected from a group comprising Indazapyroxamet,
   (34) one or more Mineral oil which includes paraffinic oils,
   (35) a plant extract selected from a group comprising Garlic extract, Neem extract, Tea tree oil, Clove oil,
   (36) a monoterpene alcohol extracted from essential oils selected from a group comprising Citronella oil, Rose oil and Palmarosa oil,
   (37) a repellant selected from a group comprising Thymol and Citronella; and
   (38) one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids.

The present invention further specifically provides the mixture combination comprising Tau-fluvalinate and at least one crop protection chemical selected from a group comprising Gamma-cyhalothrin, Alpha-cypermethrin, Etofenprox, Tefluthrin, Flupyradifurone, Flupyrimin, Triflumezopyrim, Chlorfenapyr, Brochlorfenapyr, Tetrachlorantraniliprole, Thiotraniliprole, Bensultap, Cartap hydrochloride, Thiocyclam, Thisultap-sodium, Fenazaquin, Pyridaben, Pyrimidifen, Tebufenpyrad, Cyetpyrafen, Fluxametamide, Isocycloseram, Fenoxycarb, Milbemectin, Lepimectin, Metaflumizone, Diflubenzuron, Flufenoxuron, Lufenuron, Teflubenzuron, Chlorfluazuron, Spidoxamat, Spirodiclofen, Spiromesifen, Beauveria spp, Metarhizium spp, Paecilomyces spp, Cydia pomonella GV, Thaumatotibia leucotreta GV, Anticarsia gemmatalis MNPV, Helicoverpa armigera NPV, Flometoquin, Buprofezin, Chromafenozide, Halofenozide, Methoxyfenozide, Tebufenozide, Acequinocyl, Fluacrypyrim, Hydramethylnon, Clotoria Ternatea, GS-omega/kappa HXTX-Hv1a peptide, Acynonapyr, N-octyl bicycloheptene dicarboximide (MGK-264), Piprotal, Propyl isome, Sesamex, Sesamolin and Sulfoxide, Pydiflumetofen, Fluazinam, Fluxapyroxad, Difenoconazole, Tebuconazole, Fludioxonil, Azoxystrobin, Mancozeb, Cycloxaprid, Guadipyr, Imidaclothiz, Cyflumetofen, Sila-Cyflumetofen, Cyproflanilide, Dicloromezotiaz, Fenmezoditiaz, Dimpropyridaz, Tyclopyrazoflor, Fluchlordiniliprole, Fluazaindolizine, Flufiprole, Nicofluprole, Pyriprole, Fluhexafon, Bistrifluron, Trifluenfuronate, Lotilaner, Indazapyroxamet, Mineral oil, Garlic extract, Neem extract, Tea tree oil, Clove oil, Citronella oil, Rose oil, Palmarosa oil, Thymol, Citronella and also agrochemically acceptable additives.

Furthermore, it is found in the present invention that simultaneous, that is jointly or separately, application of Tau-fluvalinate and one or more active compounds II or successive application of compound I and one or more active compounds II, as mentioned above, allows enhanced control of pests compared to the control rates that are possible with the individual compounds.

The present invention provides the mixture combination, wherein the weight ratio of Tau-fluvalinate and one or more active compounds II, as mentioned above is from 1:100 to 100:1, and the amount of each active ingredient is about 0.1-99 wt. %, about 0.1-95 wt. %, or about 0.1-90 wt. %, based on the total weight of the mixture composition.

The present invention provides mixture combination comprising Tau-fluvalinate and one or more active compounds II, as mentioned above, wherein the application rates of the mixture according to the invention are from 1 g/ha to 1000 g/ha.

The present invention further provides a mixture combination comprising a mixture of Tau-fluvalinate and one or more active compounds II, as mentioned above, comprising an agriculturally acceptable carrier, and further comprising at least one surfactant, solid diluent, liquid diluent, or a combination thereof.

This present invention also provides a method for controlling insects comprising contacting the insect or their food supply, habitat, breeding grounds or their locus with an effective amount of the mixture of Tau-fluvalinate and one or more active compounds II, as mentioned above or the composition thereof, so as to thereby control insects.

The present invention further provides a method for protecting plants from attack or infestation by insects comprising contacting the plant, or the soil or water in which the plant is growing, with an effective amount of the mixture of Tau-fluvalinate and one or more active compounds II, as mentioned above or the composition thereof, so as to thereby protect plants from attack or infestation by insects.

This present invention also provides a method for enhancing knock-down activity and/or prolonged control comprising contacting the plant, or the soil or water in which the plant is growing, with an effective amount of the mixture of Tau-fluvalinate and one or more active compounds II, as mentioned above or the composition thereof, so as to thereby enhance knock-down activity and/or prolonged control.

This present invention further provides a method for enhancing plant development comprising applying to the plant, a locus of the plant and/or propagation material of the plant an effective amount of the mixture of Tau-fluvalinate and one or more active compounds II, as mentioned above or the composition thereof, so as to thereby enhance plant development.

Furthermore, this present invention provides a method for regulating plant growth comprising applying to the plant, a locus of the plant and/or propagation material of the plant an effective amount of Tau-fluvalinate and one or more active compounds II, as mentioned above or the composition thereof, so as to thereby regulate plant growth.

### DETAILED DESCRIPTION OF THE PRESENT INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the term “crop protection chemical” is meant to include, but are not limited to an herbicide, an insecticide, a fungicide, an insect growth regulator and a microbial disruptor. Insect growth regulators (IGR) are substances that interrupt and/or inhibit the life cycle of insect pests. IGRs include juvenile hormone mimics, ecdysone agonists and chitin synthesis inhibitors. As an insect grows, it molts, growing a new exoskeleton under its old one and then shedding the old one in order to allow the new one to swell to a new size and harden. IGRs prevent an insect from reaching maturity by interfering with the molting process.

As used herein, the term “pests” is used to include animal pests, as well as harmful fungi.

As used herein, the term “AI” refers to active ingredient.

As used herein, the terms “control” or “controlling” are meant to include, but are not limited to, any killing, growth regulating, inhibiting or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity. The terms “control” and “controlling” also include the ability to modulate or inhibit the growth or proliferation or colony formation of an organism or an organism population.

As used herein the term “knock-down activity” or “knock-down treatment” means an application of one or more insecticides for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “prolonged control” means obtaining insecticidal activity over an extended period after the application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the term “effective” when used to describe a method for controlling of undesired pest, such as nematodes, means that the method provides a good level of control of the undesired pest without significantly interfering with the normal growth and development of the crop.

As used herein, the term “effective amount” when used in connection with an active component refers to an amount of the active component that, when ingested, contacted with or sensed, is sufficient to achieve a good level of control or activity.

As used herein, the term “effective amount” when used in connection with a non-active component, i.e. additive, such as polymer and organic carrier, refers to an amount of the additive that is sufficient to improve the stability of the composition.

As used herein, the term “agriculturally acceptable carrier” means carrier which is known and accepted in the art for the formation of compositions for agricultural or horticultural use.

As used herein, the term “adjuvant” is broadly defined as any substance that itself is not an active ingredient, but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable additives” is defined as any substance that itself is not an active ingredient but is added to the composition such as thickening agent, sticking agents, surfactants, anti-oxidation agent, anti-foaming agents and thickeners.

As used herein, the term “tank mix” means that two or more chemical pesticides or compositions are mixed in the spray tank at the time of spray application.

As used herein, the term “ready mix” means a composition that may be applied to plants directly after dilution. The composition comprises the combination of the active ingredients. The term “mixture” or “combination” refers, but is not limited to, a combination in any physical form, e.g., blend, solution, alloy, or the like.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil.

As used herein, the term “locus” includes a habitat, breeding ground, plant, propagation material, soil, area, material or environment in which a pest is growing or may grow.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”.

As used herein, the term “locus” includes a habitat, breeding ground, plant, propagation material, soil, area, material or environment in which a pest is growing or may grow.

As used herein the term “ha” refers to hectare.

As used herein, the term “g” refers to gram, and “L” or “l” refers to litre.

The term, “ppm” is an abbreviation for “parts per million” and it also can be expressed as milligrams per liter (mg/L). This measurement is the mass of a chemical or contaminate per unit volume of water or solvent in a formulation.

As used herein, the term “mixture” or “combination” refers, but is not limited to, a combination in any physical form, e.g., blend, solution, suspension, dispersion, emulsion, alloy, or the like.

As used herein, the term “more effective” includes, but is not limited to, increasing efficacy of pesticidal disease control, prolonging protection and reducing the amount of time needed to achieve a given level of pesticidal control, prolonging the duration of protection against pest attack after application and extending the protection period against pest attack and/or reducing the amount of time needed to achieve a level of pest control compared to when each pesticide at the same amount is applied alone.

The term “enhancing crop plants” as used herein means improving one or more of plant quality, plant vigor, nutrient uptake, root system, tolerance to stress factors, and/or yield in a plant to which the mixture or composition described herein has been applied as compared to a control plant grown under the same conditions except to which the mixture or composition described herein has not been applied.

The term “enhancing roots system” as used herein means the roots system is improved qualitatively or quantitatively in a plant to which the mixture or composition described herein has been applied as compared to the roots systems in a control plant grown under the same conditions except to which the mixture or composition described herein has not been applied. Enhanced roots systems include but are not limited to improved visual appearance and composition of the roots system (i.e., improved color, density, and uniformity), increased root growth, a more developed root system, stronger and healthier roots, improved plant stand, and increased roots system weight.

The term “improving plant quality” as used herein means that one or more traits are improved qualitatively or quantitatively in a plant to which the mixture or composition described herein has been applied as compared to the same trait in a control plant grown under the same conditions except to which the mixture or composition described herein has not been applied. Such traits include but are not limited to improved visual appearance and composition of the plant (i.e., improved color, density, uniformity, compactness), reduced ethylene (reduced production and/or inhibition of reception), improved visual appearance and composition of harvested material (i.e., seeds, fruits, leaves, vegetables, shoot/stem/cane), improved carbohydrate content (i.e., increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e., improved taste), improved consumer health benefits (i.e., increased levels of vitamins and antioxidants), improved post-harvest characteristics (i.e., enhanced shelf-life and/or storage stability, easier processability, easier extraction of compounds), and/or improved seed quality (i.e., for use in following seasons).

As used herein, the term “plant growth regulation” or “regulating plant growth” includes restricting vertical stem growth, promoting root growth, stunting, increasing stem diameter and stem-wall thickness, and the like.

As used herein, the term “plants” refers to any and all physical parts of a plant, including but not limited to seeds, seedlings, saplings, roots, tubers, stems, stalks, foliage, and fruits.

As used herein, the term “surfactant” means an agriculturally acceptable material which imparts emulsifiability, stability, spreading, wetting, dispersibility or other surface-modifying properties. Examples of suitable surfactants include non-ionic, anionic, cationic and ampholytic surfactants.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

Unless otherwise specified, references to percentages are by weight (wt.) percentages of the active compounds in the composition of this invention are based on the total weight of active ingredients in the composition, i.e., the active compounds themselves, exclusive of any amounts of solvents, carriers, dispersants, stabilizers or other materials which may be present.

It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

When a ratio herein is to be “X:1 or higher”, it is meant that the ratio is Y:1, where Y is X or greater, and when a ratio is herein to be “X:1 or lower”, it is meant that the ratio is Z:1, where Z is X or less. The same logic follows for ratios that are “1:X or higher” and “1:X or lower”.

### Pesticidal Mixtures

It has been surprisingly found that by combining Tau fluvalinate with one or more crop protection chemicals, mixture combinations are produced, that exhibit a broad spectrum of control and high efficacy against a very wide range of insects, as well as having knock-down and long residual effect under different climate conditions. The mixtures and compositions of the present invention are based in part on the finding that application of the mixture combination of the present invention to a locus or area where pest control is desired results in improved control of pests and prevents further infestation.

In some embodiments, the combination provides a higher insecticidal activity than that envisaged on the basis of the sum of activities of each of the insecticides found therein. Such a combination allows the reduced dosages of the individual insecticides which can damage agriculturally important plants.

In an embodiment, the present invention relates to a mixture combination comprising, as active compounds:
i) Tau-fluvalinate; and
ii) at least one crop protection chemical, compound II selected from the groups (1) to (37):
   (1) a synthetic pyrethroid selected from a group consisting of Gamma-cyhalothrin, Alpha-cypermethrin, Etofenprox and Tefluthrin,
   (2) a Nicotinic acetylcholine receptor (nAChR) competitive modulator selected from a group comprising Flupyradifurone, Flupyrimin, and Triflumezopyrim,
   (3) an Uncoupler of oxidative phosphorylation via disruption of proton gradient comprising Chlorfenapyr and Brochlorfenapyr,
   (4) a Ryanodine receptor modulator selected from a group comprising Tetrachlorantraniliprole and Thiotraniliprole,
   (5) a Nicotinic acetylcholine receptor channel blocker selected from a group comprising Bensultap, Cartap hydrochloride, Thiocyclam and Thisultap-sodium,
   (6) a Mitochondrial complex electron transport inhibitor (METI) selected from a group comprising Fenazaquin, Pyridaben, Pyrimidifen, Tebufenpyrad and Cyetpyrafen,
   (7) a meta-diamide insecticide selected from a group comprising Fluxametamide and Isocycloseram,
   (8) a broad-spectrum insect growth regulator selected from a group comprising Fenoxycarb,
   (9) a Glutamate-gated chloride channel (GluCl) allosteric modulator selected from a group comprising Milbemectin and Lepimectin,
   (10) a Voltage-dependent sodium channel Blocker selected from a group comprising Metaflumizone,
   (11) an Inhibitor of chitin biosynthesis affecting CHS1, selected from a group comprising Diflubenzuron, Flufenoxuron, Lufenuron, Teflubenzuron and Chlorfluazuron,
   (12) an Inhibitor of acetyl COA carboxylase selected from a group comprising Spidoxamat, Spirodiclofen and Spiromesifen,
   (13) an Entomopathogenic fungal agent comprising Beauveria spp, Metarhizium spp and Paecilomyces spp,
   (14) a Baculovirus comprising:
      Granuloviruses such as Cydia pomonella GV, Thaumatotibia leucotreta GV,
      Nucleoopolyhedrosisvirus such as Anticarsia gemmatalis MNPV and Helicoverpa armigera NPV,
   (15) a Mitochondrial complex III electron transport inhibitors—Qi site comprising Flometoquin,
   (16) a Chitin biosynthesis inhibitor (type 1) comprising Buprofezin,
   (17) an Ecdysone receptor agonist comprising Chromafenozide, Halofenozide, Methoxyfenozide and Tebufenozide,
   (18) a Mitochondrial complex III electron transport inhibitor (Qo site) comprising Acequinocyl, Fluacrypyrim and Hydramethylnon,
   (19) a Cyclotide insecticide and repellent comprising Clotoria Ternatea,
   (20) a Nicotinic acetylcholine receptor (nAChR) allosteric modulator (site II) comprising GS-omega/kappa HXTX-Hv1a peptide,
   (21) a Calcium-activated potassium channel (KCa2) modulator comprising Acynonapyr,
   (22) an Insecticide synergist comprising N-octyl bicycloheptene dicarboximide (MGK-264), Piprotal, Propyl isome, Sesamex, Sesamolin and Sulfoxide,
   (23) a Fungicide selected from a group comprising Pydiflumetofen, Fluazinam, Fluxapyroxad, Difenoconazole, Tebuconazole, Fludioxonil, Azoxystrobin and Mancozeb,
   (24) a Neonicotinoid insecticide selected from a group comprising Cycloxaprid, Guadipyr and Imidaclothiz,
   (25) an Acaricide selected from a group comprising Cyflumetofen and Sila-Cyflumetofen,
   (26) a Diamide insecticide selected from a group comprising Cyproflanilide,
   (27) a Mesoionic insecticide selected from a group comprising Dicloromezotiaz and Fenmezoditiaz,
   (28) a Pyrazole carboxamide insecticide selected from a group comprising Dimpropyridaz, Tyclopyrazoflor, Fluchlordiniliprole,
   (29) a Sulfonamide nematicide selected from a group comprising Fluazaindolizine,
   (30) a Phenylpyrazole insecticide selected from a group comprising Flufiprole, Nicofluprole and Pyriprole,
   (31) a Fluorine containing insecticide selected from a group comprising Fluhexafon, Bistrifluron and Trifluenfuronate,
   (32) an Isoxazoline parasiticide selected from a group comprising Lotilaner,
   (33) an Indazole insecticide selected from a group comprising Indazapyroxamet,
   (34) one or more Mineral oil which includes paraffinic oils,
   (35) a plant extract selected from a group comprising Garlic extract, Neem extract, Tea tree oil, Clove oil,
   (36) a monoterpene alcohol extracted from essential oils selected from a group comprising Citronella oil, Rose oil and Palmarosa oil,
   (37) a repellant selected from a group comprising Thymol and Citronella; and
   (38) one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids.

In an embodiment, the crop protection chemical, compound II is at least one of Gamma-cyhalothrin, Alpha-cypermethrin, Etofenprox and Tefluthrin. In a specific embodiment, the crop protection chemical, compound II is Gamma-cyhalothrin. In another specific embodiment, the crop protection chemical, compound II is Alpha-cypermethrin. In another specific embodiment, the crop protection chemical, compound II is Etofenprox. In another specific embodiment, the crop protection chemical, compound II is Tefluthrin.

In an embodiment, the crop protection chemical, compound II is at least one of Flupyradifurone, Flupyrimin, and Triflumezopyrim. In a specific embodiment, the crop protection chemical, compound II is Flupyradifurone. In another specific embodiment, the crop protection chemical, compound II is Flupyrimin. In another specific embodiment, the crop protection chemical, compound II is Triflumezopyrim.

In an embodiment, the crop protection chemical, compound II is at least one of Chlorfenapyr and Brochlorfenapyr. In a specific embodiment, the crop protection chemical, compound II is Chlorfenapyr. In another embodiment, the crop protection chemical, compound II is Brochlorfenapyr.

In an embodiment, the crop protection chemical, compound II is at least one of Tetrachlorantraniliprole and Thiotraniliprole. In a specific embodiment, the crop protection chemical, compound II is Tetrachlorantraniliprole. In another embodiment, the crop protection chemical, compound II is Thiotraniliprole.

In an embodiment, the crop protection chemical, compound II is at least one of Bensultap, Cartap hydrochloride, Thiocyclam and Thisultap-sodium. In a specific embodiment, the crop protection chemical, compound II is Bensultap. In another embodiment, the crop protection chemical, compound II is Cartap hydrochloride. In another embodiment, the crop protection chemical, compound II is Thiocyclam. In another embodiment, the crop protection chemical, compound II is Thisultap-sodium.

In an embodiment, the crop protection chemical, compound II is at least one of Fenazaquin, Pyridaben, Pyrimidifen, Tebufenpyrad and Cyetpyrafen. In a specific embodiment, the crop protection chemical, compound II is Fenazaquin. In another embodiment, the crop protection chemical, compound II is Pyridaben. In another embodiment, the crop protection chemical, compound II is Pyrimidifen. In another embodiment, the crop protection chemical, compound II is Tebufenpyrad. In another embodiment, the crop protection chemical, compound II is Cyetpyrafen.

In an embodiment, the crop protection chemical, compound II is at least one of Fluxametamide and Isocycloseram. In a specific embodiment, the crop protection chemical, compound II is Fluxametamide. In another embodiment, the crop protection chemical, compound II is Isocycloseram.

In a further embodiment, the crop protection chemical, compound II is Fenoxycarb.

In an embodiment, the crop protection chemical, compound II is at least one of Milbemectin and Lepimectin. In a specific embodiment, the crop protection chemical, compound II is Milbemectin. In another embodiment, the crop protection chemical, compound II is Lepimectin.

In a further embodiment, the crop protection chemical, compound II is Metaflumizone.

In an embodiment, the crop protection chemical, compound II is at least one of Diflubenzuron, Flufenoxuron, Lufenuron, Teflubenzuron and Chlorfluazuron. In a specific embodiment, the crop protection chemical, compound II is Diflubenzuron. In another embodiment, the crop protection chemical, compound II is Flufenoxuron. In another embodiment, the crop protection chemical, compound II is Lufenuron. In another embodiment, the crop protection chemical, compound II is Teflubenzuron. In another embodiment, the crop protection chemical, compound II is Chlorfluazuron.

In an embodiment, the crop protection chemical, compound II is at least one of Spidoxamat, Spirodiclofen and Spiromesifen. In a specific embodiment, the crop protection chemical, compound II is Spidoxamat. In another embodiment, the crop protection chemical, compound II is Spirodiclofen. In another embodiment, the crop protection chemical, compound II is Spiromesifen.

In an embodiment, the crop protection chemical, compound II is at least one of Cydia pomonella GV and Thaumatotibia leucotreta GV. In a specific embodiment, the crop protection chemical, compound II is Cydia pomonella GV. In another embodiment, the crop protection chemical, compound II is Thaumatotibia leucotreta GV.

In an embodiment, the crop protection chemical, compound II is at least one of Anticarsia gemmatalis MNPV and Helicoverpa armigera NPV. In a specific embodiment, the crop protection chemical, compound II is Anticarsia gemmatalis MNPV. In another embodiment, the crop protection chemical, compound II is Helicoverpa armigera NPV.

In a further embodiment, the crop protection chemical, compound II is Flometoquin.

In a further embodiment, the crop protection chemical, compound II is Buprofezin.

In an embodiment, the crop protection chemical, compound II is at least one of Chromafenozide, Halofenozide, Methoxyfenozide and Tebufenozide. In a specific embodiment, the crop protection chemical, compound II is Chromafenozide. In another embodiment, the crop protection chemical, compound II is Halofenozide. In another embodiment, the crop protection chemical, compound II is Methoxyfenozide. In another embodiment, the crop protection chemical, compound II is Tebufenozide.

In an embodiment, the crop protection chemical, compound II is at least one of Acequinocyl, Fluacrypyrim and Hydramethylnon. In a specific embodiment, the crop protection chemical, compound II is Acequinocyl. In another embodiment, the crop protection chemical, compound II is Fluacrypyrim. In another embodiment, the crop protection chemical, compound II is Hydramethylnon.

In a further embodiment, the crop protection chemical, compound II is Clotoria Ternatea.

In a further embodiment, the crop protection chemical, compound II is GS-omega/kappa HXTX-Hv1a peptide.

In a further embodiment, the crop protection chemical, compound II is Acynonapyr.

In an embodiment, the crop protection chemical, compound II is at least one of N-octyl bicycloheptene dicarboximide (MGK-264), Piprotal, Propyl isome, Sesamex, Sesamolin and Sulfoxide. In a specific embodiment, the crop protection chemical, compound II is N-octyl bicycloheptene dicarboximide (MGK-264). In another embodiment, the crop protection chemical, compound II is Piprotal. In another embodiment, the crop protection chemical, compound II is Propyl isome. In another embodiment, the crop protection chemical, compound II is Sesamex. In another embodiment, the crop protection chemical, compound II is Sesamolin. In another embodiment, the crop protection chemical, compound II is Sulfoxide.

In an embodiment, the crop protection chemical, compound II is at least one of Pydiflumetofen, Fluazinam, Fluxapyroxad, Difenoconazole, Tebuconazole, Fludioxonil, Azoxystrobin and Mancozeb. In a specific embodiment, the crop protection chemical, compound II is Pydiflumetofen. In another embodiment, the crop protection chemical, compound II is Fluazinam. In another embodiment, the crop protection chemical, compound II is Fluxapyroxad. In another embodiment, the crop protection chemical, compound II is Difenoconazole. In another embodiment, the crop protection chemical, compound II is Tebuconazole. In another embodiment, the crop protection chemical, compound II is Fludioxonil. In another embodiment, the crop protection chemical, compound II is Azoxystrobin. In another embodiment, the crop protection chemical, compound II is Mancozeb.

In an embodiment, the crop protection chemical, compound II is at least one of Cycloxaprid, Guadipyr and Imidaclothiz. In a specific embodiment, the crop protection chemical, compound II is Cycloxaprid. In another embodiment, the crop protection chemical, compound II is Guadipyr. In another embodiment, the crop protection chemical, compound II is Imidaclothiz.

In an embodiment, the crop protection chemical, compound II is at least one of Cyflumetofen and Sila-Cyflumetofen. In a specific embodiment, the crop protection chemical, compound II is Cyflumetofen. In another embodiment, the crop protection chemical, compound II is Sila-Cyflumetofen.

In a further embodiment, the crop protection chemical, compound II is Cyproflanilide.

In an embodiment, the crop protection chemical, compound II is at least one of Dicloromezotiaz and Fenmezoditiaz. In a specific embodiment, the crop protection chemical, compound II is Dicloromezotiaz. In another embodiment, the crop protection chemical, compound II is Fenmezoditiaz.

In an embodiment, the crop protection chemical, compound II is at least one of Dimpropyridaz, Tyclopyrazoflor and Fluchlordiniliprole. In a specific embodiment, the crop protection chemical, compound II is Dimpropyridaz. In another embodiment, the crop protection chemical, compound II is Tyclopyrazoflor. In another embodiment, the crop protection chemical, compound II is Fluchlordiniliprole.

In a further embodiment, the crop protection chemical, compound II is Fluazaindolizine.

In an embodiment, the crop protection chemical, compound II is at least one of Flufiprole, Nicofluprole and Pyriprole. In a specific embodiment, the crop protection chemical, compound II is Flufiprole. In another embodiment, the crop protection chemical, compound II is Nicofluprole. In another embodiment, the crop protection chemical, compound II is Pyriprole.

In an embodiment, the crop protection chemical, compound II is at least one of Fluhexafon, Bistrifluron and Trifluenfuronate. In a specific embodiment, the crop protection chemical, compound II is Fluhexafon. In another embodiment, the crop protection chemical, compound II is Bistrifluron. In another embodiment, the crop protection chemical, compound II is Trifluenfuronate.

In a further embodiment, the crop protection chemical, compound II is Lotilaner.

In a further embodiment, the crop protection chemical, compound II is Indazapyroxamet.

In an embodiment, the crop protection chemical, compound II is at least one of one or more Mineral oils which includes paraffinic oils. In a specific embodiment, the crop protection chemical, compound II is paraffinic oil.

In an embodiment, the crop protection chemical, compound II is at least one of Garlic extract, Neem extract, Tea tree oil and Clove oil. In a specific embodiment, the crop protection chemical, compound II is Garlic extract. In another embodiment, the crop protection chemical, compound II is Neem extract. In another embodiment, the crop protection chemical, compound II is Tea tree oil. In another embodiment, the crop protection chemical, compound II is Clove oil.

In an embodiment, the crop protection chemical, compound II is a monoterpene alcohol extracted from essential oils selected from a group comprising Citronella oil, Rose oil and Palmarosa oil. In a specific embodiment, the crop protection chemical, compound II is Geraniol.

In an embodiment, the crop protection chemical, compound II is at least one of Thymol and Citronella. In a specific embodiment, the crop protection chemical, compound II is Thymol. In another embodiment, the crop protection chemical, compound II is Citronella.

In an embodiment, the crop protection chemical, compound II is at least one of Diatomaceous earth, Amorphous silica, Hydroxylpropyl methylcellulose, Kaolin (calcined), Polydimethylsiloxane and Potassium salts of fatty acids. In a specific embodiment, the crop protection chemical, compound II is Diatomaceous earth. In another embodiment, the crop protection chemical, compound II is Amorphous silica. In another embodiment, the crop protection chemical, compound II is Hydroxylpropyl methylcellulose. In another embodiment, the crop protection chemical, compound II is Kaolin (calcined). In another embodiment, the crop protection chemical, compound II is Polydimethylsiloxane. In another embodiment, the crop protection chemical, compound II is Potassium salts of fatty acids.

The weight ratio between Tau-fluvalinate and at least one crop protection chemical, compound II, as defined above, varies depending upon various conditions such as the type of the formulation, weather conditions, the type of crop and the type of pests.

In one embodiment, the weight ratio of Tau-fluvalinate to the crop protection chemical, compound II is from about 1:100 to 100:1. In another embodiment, the weight ratio of the Tau-fluvalinate to the crop protection chemical, compound II is from about 1:50 to 50:1.

The weight ratio of the Tau-fluvalinate to the crop protection chemical, compound II may be any in-between range selected from the above indicated ratios.

In one embodiment, the weight ratio of Tau-fluvalinate to synthetic pyrethroid is from about 1:100 to 100:1. In another embodiment, the weight ratio of Tau-fluvalinate to synthetic pyrethroid is from about 1:50 to 50:1. The weight ratio of Tau-fluvalinate to synthetic pyrethroid may be any in-between range selected from the above indicated ratios.

In a specific embodiment, the weight ratio of Tau-fluvalinate to Gamma-cyhalothrin is from about 1:100 to 100:1. In another embodiment, the weight ratio of Tau-fluvalinate to Gamma-cyhalothrin is from about 1:50 to 50:1.

In a specific embodiment, the weight ratio of Tau-fluvalinate to Alpha-cypermethrin is from about 1:100 to 100:1. In another embodiment, the weight ratio of Tau-fluvalinate to Alpha-cypermethrin is from about 1:50 to 50:1.

In a specific embodiment, the weight ratio of Tau-fluvalinate to Etofenprox is from about 1:100 to 100:1. In another embodiment, the weight ratio of Tau-fluvalinate to Etofenprox is from about 1:50 to 50:1.

In a specific embodiment, the weight ratio of Tau-fluvalinate to Tefluthrin is from about 1:100 to 100:1. In another embodiment, the weight ratio of Tau-fluvalinate to Tefluthrin is from about 1:50 to 50:1.

In one embodiment, the weight ratio of Tau-fluvalinate to Nicotinic acetylcholine receptor (nAChR) competitive modulator is from about 1:100 to 100:1. In another embodiment, the weight ratio of Tau-fluvalinate to Nicotinic acetylcholine receptor (nAChR) competitive modulator is from about 1:50 to 50:1. The weight ratio of Tau-fluvalinate to Nicotinic acetylcholine receptor (nAChR) competitive modulator may be any in-between range selected from the above indicated ratios.

In a specific embodiment, the weight ratio of Tau-fluvalinate to Flupyradifurone is from about 1:100 to 100:1. In another embodiment, the weight ratio of Tau-fluvalinate to Flupyradifurone is from about 1:50 to 50:1.

In a specific embodiment, the weight ratio of Tau-fluvalinate to Flupyrimin is from about 1:100 to 100:1. In another embodiment, the weight ratio of Tau-fluvalinate to Flupyrimin is from about 1:50 to 50:1.

In a more specific embodiment, the weight ratio of Tau-fluvalinate to Flupyrimin is from about 1:10 to 10:1.

In a specific embodiment, the weight ratio of Tau-fluvalinate to Triflumezopyrim is from about 1:100 to 100:1. In another embodiment, the weight ratio of Tau-fluvalinate to Triflumezopyrim is from about 1:50 to 50:1.

In one embodiment, the weight ratio of Tau-fluvalinate to Uncoupler of oxidative phosphorylation via disruption of proton gradient is from about 1:100 to 100:1. In another embodiment, the weight ratio of Tau-fluvalinate to Uncoupler of oxidative phosphorylation via disruption of proton gradient is from about 1:50 to 50:1. The weight ratio of Tau-fluvalinate to Uncoupler of oxidative phosphorylation via disruption of proton gradient may be any in-between range selected from the above indicated ratios.

In a specific embodiment, the weight ratio of Tau-fluvalinate to Chlorfenapyr is from about 1:100 to 100:1. In another embodiment, the weight ratio of Tau-fluvalinate to Chlorfenapyr is from about 1:50 to 50:1.

In a specific embodiment, the weight ratio of Tau-fluvalinate to Brochlorfenapyr is from about 1:100 to 100:1. In another embodiment, the weight ratio of Tau-fluvalinate to Brochlorfenapyr is from about 1:50 to 50:1.

In one embodiment, the weight ratio of Tau-fluvalinate to Ryanodine receptor modulator is from about 1:100 to 100:1. In another embodiment, the weight ratio of Tau-fluvalinate to Ryanodine receptor modulator is from about 1:50 to 50:1. The weight ratio of Tau-fluvalinate to Ryanodine receptor modulator may be any in-between range selected from the above indicated ratios.

In a specific embodiment, the weight ratio of Tau-fluvalinate to Tetrachlorantraniliprole is from about 1:100 to 100:1. In another embodiment, the weight ratio of Tau-fluvalinate to Tetrachlorantraniliprole is from about 1:50 to 50:1.

In a specific embodiment, the weight ratio of Tau-fluvalinate to Thiotraniliprole is from about 1:100 to 100:1. In another embodiment, the weight ratio of Tau-fluvalinate to Thiotraniliprole is from about 1:50 to 50:1.

In one embodiment, the weight ratio of Tau-fluvalinate to Nicotinic acetylcholine receptor channel blocker is from about 1:100 to 100:1. In another embodiment, the weight ratio of Tau-fluvalinate to Nicotinic acetylcholine receptor channel blocker is from about 1:50 to 50:1. The weight ratio of Tau-fluvalinate to Nicotinic acetylcholine receptor channel blocker may be any in-between range selected from the above indicated ratios.

In a specific embodiment, the weight ratio of Tau-fluvalinate to Bensultap is from about 1:100 to 100:1. In another embodiment, the weight ratio of Tau-fluvalinate to Bensultap is from about 1:50 to 50:1.

In a specific embodiment, the weight ratio of Tau-fluvalinate to Cartap hydrochloride is from about 1:100 to 100:1. In another embodiment, the weight ratio of Tau-fluvalinate to Cartap hydrochloride is from about 1:50 to 50:1.

In a specific embodiment, the weight ratio of Tau-fluvalinate to Thiocyclam is from about 1:100 to 100:1. In another embodiment, the weight ratio of Tau-fluvalinate to Thiocyclam is from about 1:50 to 50:1.

In a specific embodiment, the weight ratio of Tau-fluvalinate to Thisultap-sodium is from about 1:100 to 100:1. In another embodiment, the weight ratio of Tau-fluvalinate to Thisultap-sodium is from about 1:50 to 50:1.

In one embodiment, the weight ratio of Tau-fluvalinate to Mitochondrial complex electron transport inhibitor (METI) is from about 1:100 to 100:1. In another embodiment, the weight ratio of Tau-fluvalinate to Mitochondrial complex electron transport inhibitor (METI) is from about 1:50 to 50:1. The weight ratio of Tau-fluvalinate to Mitochondrial complex electron transport inhibitor (METI) may be any in-between range selected from the above indicated ratios.

In a specific embodiment, the weight ratio of Tau-fluvalinate to Fenazaquin is from about 1:100 to 100:1. In another embodiment, the weight ratio of Tau-fluvalinate to Fenazaquin is from about 1:50 to 50:1.

In a specific embodiment, the weight ratio of Tau-fluvalinate to Pyridaben is from about 1:100 to 100:1. In another embodiment, the weight ratio of Tau-fluvalinate to Pyridaben is from about 1:50 to 50:1.

In a specific embodiment, the weight ratio of Tau-fluvalinate to Pyrimidifen is from about 1:100 to 100:1. In another embodiment, the weight ratio of Tau-fluvalinate to Pyrimidifen is from about 1:50 to 50:1.

In a specific embodiment, the weight ratio of Tau-fluvalinate to Tebufenpyrad is from about 1:100 to 100:1. In another embodiment, the weight ratio of Tau-fluvalinate to Tebufenpyrad is from about 1:50 to 50:1.

In a specific embodiment, the weight ratio of Tau-fluvalinate to Cyetpyrafen is from about 1:100 to 100:1. In another embodiment, the weight ratio of Tau-fluvalinate to Cyetpyrafen is from about 1:50 to 50:1.

In one embodiment, the weight ratio of Tau-fluvalinate to meta-diamide insecticide is from about 1:100 to 100:1. In another embodiment, the weight ratio of Tau-fluvalinate to meta-diamide insecticide is from about 1:50 to 50:1. The weight ratio of Tau-fluvalinate to meta-diamide insecticide may be any in-between range selected from the above indicated ratios.

In a specific embodiment, the weight ratio of Tau-fluvalinate to Fluxametamide is from about 1:100 to 100:1. In another embodiment, the weight ratio of Tau-fluvalinate to Fluxametamide is from about 1:50 to 50:1.

In a specific embodiment, the weight ratio of Tau-fluvalinate to Isocycloseram is from about 1:100 to 100:1. In another embodiment, the weight ratio of Tau-fluvalinate to Isocycloseram is from about 1:50 to 50:1.

In a more specific embodiment, the weight ratio of Tau-fluvalinate to Isocycloseram is from about 1:1 to 5:1.

In one embodiment, the weight ratio of Tau-fluvalinate to broad-spectrum insect growth regulator is from about 1:100 to 100:1. In another embodiment, the weight ratio of Tau-fluvalinate to broad-spectrum insect growth regulator is from about 1:50 to 50:1. The weight ratio of Tau-fluvalinate to broad-spectrum insect growth regulator may be any in-between range selected from the above indicated ratios.

In a specific embodiment, the weight ratio of Tau-fluvalinate to Fenoxycarb is from about 1:100 to 100:1. In another embodiment, the weight ratio of Tau-fluvalinate to Fenoxycarb is from about 1:50 to 50:1.

In one embodiment, the weight ratio of Tau-fluvalinate to Glutamate-gated chloride channel (GluCl) allosteric modulator is from about 1:100 to 100:1. In another embodiment, the weight ratio of Tau-fluvalinate to Glutamate-gated chloride channel (GluCl) allosteric modulator is from about 1:50 to 50:1. The weight ratio of Tau-fluvalinate to Glutamate-gated chloride channel (GluCl) allosteric modulator may be any in-between range selected from the above indicated ratios.

In a specific embodiment, the weight ratio of Tau-fluvalinate to Milbemectin is from about 1:100 to 100:1. In another embodiment, the weight ratio of Tau-fluvalinate to Milbemectin is from about 1:50 to 50:1.

In a specific embodiment, the weight ratio of Tau-fluvalinate to Lepimectin is from about 1:100 to 100:1. In another embodiment, the weight ratio of Tau-fluvalinate to Lepimectin is from about 1:50 to 50:1.

In one embodiment, the weight ratio of Tau-fluvalinate to Voltage-dependent sodium channel Blocker is from about 1:100 to 100:1. In another embodiment, the weight ratio of Tau-fluvalinate to Voltage-dependent sodium channel Blocker is from about 1:50 to 50:1. The weight ratio of Tau-fluvalinate to Voltage-dependent sodium channel Blocker may be any in-between range selected from the above indicated ratios.

In a specific embodiment, the weight ratio of Tau-fluvalinate to Metaflumizone is from about 1:100 to 100:1. In another embodiment, the weight ratio of Tau-fluvalinate to Metaflumizone is from about 1:50 to 50:1.

In one embodiment, the weight ratio of Tau-fluvalinate to Inhibitor of chitin biosynthesis affecting CHS1 is from about 1:100 to 100:1. In another embodiment, the weight ratio of Tau-fluvalinate to Inhibitor of chitin biosynthesis affecting CHS1 is from about 1:50 to 50:1. The weight ratio of Tau-fluvalinate to Inhibitor of chitin biosynthesis affecting CHS1 may be any in-between range selected from the above indicated ratios.

In a specific embodiment, the weight ratio of Tau-fluvalinate to Diflubenzuron is from about 1:100 to 100:1. In another embodiment, the weight ratio of Tau-fluvalinate to Diflubenzuron is from about 1:50 to 50:1.

In a specific embodiment, the weight ratio of Tau-fluvalinate to Flufenoxuron is from about 1:100 to 100:1. In another embodiment, the weight ratio of Tau-fluvalinate to Flufenoxuron is from about 1:50 to 50:1.

In a specific embodiment, the weight ratio of Tau-fluvalinate to Lufenuron is from about 1:100 to 100:1. In another embodiment, the weight ratio of Tau-fluvalinate to Lufenuron is from about 1:50 to 50:1.

In a specific embodiment, the weight ratio of Tau-fluvalinate to Teflubenzuron is from about 1:100 to 100:1. In another embodiment, the weight ratio of Tau-fluvalinate to Teflubenzuron is from about 1:50 to 50:1.

In a specific embodiment, the weight ratio of Tau-fluvalinate to Chlorfluazuron is from about 1:100 to 100:1. In another embodiment, the weight ratio of Tau-fluvalinate to Chlorfluazuron is from about 1:50 to 50:1.

In one embodiment, the weight ratio of Tau-fluvalinate to Inhibitor of Inhibitor of acetyl CoA carboxylase is from about 1:100 to 100:1. In another embodiment, the weight ratio of Tau-fluvalinate to Inhibitor of acetyl COA carboxylase is from about 1:50 to 50:1. The weight ratio of Tau-fluvalinate to Inhibitor of acetyl CoA carboxylase may be any in-between range selected from the above indicated ratios.

In a specific embodiment, the weight ratio of Tau-fluvalinate to Spidoxamat is from about 1:100 to 100:1. In another embodiment, the weight ratio of Tau-fluvalinate to Spidoxamat is from about 1:50 to 50:1.

In a specific embodiment, the weight ratio of Tau-fluvalinate to Spirodiclofen is from about 1:100 to 100:1. In another embodiment, the weight ratio of Tau-fluvalinate to Spirodiclofen is from about 1:50 to 50:1.

In a specific embodiment, the weight ratio of Tau-fluvalinate to Spiromesifen is from about 1:100 to 100:1. In another embodiment, the weight ratio of Tau-fluvalinate to Spiromesifen is from about 1:50 to 50:1.

In one embodiment, the weight ratio of Tau-fluvalinate to Entomopathogenic fungal agent is from about 1:100 to 100:1. In another embodiment, the weight ratio of Tau-fluvalinate to Entomopathogenic fungal agent is from about 1:50 to 50:1. The weight ratio of Tau-fluvalinate to Entomopathogenic fungal agent may be any in-between range selected from the above indicated ratios.

In a specific embodiment, the weight ratio of Tau-fluvalinate to Beauveria spp is from about 1:100 to 100:1. In another embodiment, the weight ratio of Tau-fluvalinate to Beauveria spp is from about 1:50 to 50:1.

In a specific embodiment, the weight ratio of Tau-fluvalinate to Metarhizium spp is from about 1:100 to 100:1. In another embodiment, the weight ratio of Tau-fluvalinate to Metarhizium spp is from about 1:50 to 50:1.

In a specific embodiment, the weight ratio of Tau-fluvalinate to Paecilomyces spp is from about 1:100 to 100:1. In another embodiment, the weight ratio of Tau-fluvalinate to Paecilomyces spp is from about 1:50 to 50:1.

In one embodiment, the weight ratio of Tau-fluvalinate to Granulovirusesis from about 1:100 to 100:1. In another embodiment, the weight ratio of Tau-fluvalinate to Granuloviruses is from about 1:50 to 50:1. The weight ratio of Tau-fluvalinate to Granuloviruses may be any in-between range selected from the above indicated ratios.

In a specific embodiment, the weight ratio of Tau-fluvalinate to Cydia pomonella GV is from about 1:100 to 100:1. In another embodiment, the weight ratio of Tau-fluvalinate to Cydia pomonella GV is from about 1:50 to 50:1.

In a specific embodiment, the weight ratio of Tau-fluvalinate to Thaumatotibia leucotreta GV is from about 1:100 to 100:1. In another embodiment, the weight ratio of Tau-fluvalinate to Thaumatotibia leucotreta GV is from about 1:50 to 50:1.

In one embodiment, the weight ratio of Tau-fluvalinate to Nucleoopolyhedrosisvirus is from about 1:100 to 100:1. In another embodiment, the weight ratio of Tau-fluvalinate to Nucleoopolyhedrosisvirus is from about 1:50 to 50:1. The weight ratio of Tau-fluvalinate to Nucleoopolyhedrosisvirus may be any in-between range selected from the above indicated ratios.

In a specific embodiment, the weight ratio of Tau-fluvalinate to Anticarsia gemmatalis MNPV is from about 1:100 to 100:1. In another embodiment, the weight ratio of Tau-fluvalinate to Anticarsia gemmatalis MNPV is from about 1:50 to 50:1.

In a specific embodiment, the weight ratio of Tau-fluvalinate to Helicoverpa armigera NPV is from about 1:100 to 100:1. In another embodiment, the weight ratio of Tau-fluvalinate to Helicoverpa armigera NPV is from about 1:50 to 50:1.

In one embodiment, the weight ratio of Tau-fluvalinate to Mitochondrial complex III electron transport inhibitors—Qi site is from about 1:100 to 100:1. In another embodiment, the weight ratio of Tau-fluvalinate to Mitochondrial complex III electron transport inhibitors—Qi site is from about 1:50 to 50:1. The weight ratio of Tau-fluvalinate to Mitochondrial complex III electron transport inhibitors—Qi site may be any in-between range selected from the above indicated ratios.

In a specific embodiment, the weight ratio of Tau-fluvalinate to Flometoquin is from about 1:100 to 100:1. In another embodiment, the weight ratio of Tau-fluvalinate to Flometoquin is from about 1:50 to 50:1.

In one embodiment, the weight ratio of Tau-fluvalinate to Chitin biosynthesis inhibitor (type 1) is from about 1:100 to 100:1. In another embodiment, the weight ratio of Tau-fluvalinate to Chitin biosynthesis inhibitor (type 1) is from about 1:50 to 50:1. The weight ratio of Tau-fluvalinate to Chitin biosynthesis inhibitor (type 1) may be any in-between range selected from the above indicated ratios.

In a specific embodiment, the weight ratio of Tau-fluvalinate to Buprofezin is from about 1:100 to 100:1. In another embodiment, the weight ratio of Tau-fluvalinate to Buprofezin is from about 1:50 to 50:1.

In one embodiment, the weight ratio of Tau-fluvalinate to Ecdysone receptor is from about 1:100 to 100:1. In another embodiment, the weight ratio of Tau-fluvalinate to Ecdysone receptor is from about 1:50 to 50:1. The weight ratio of Tau-fluvalinate to Ecdysone receptor may be any in-between range selected from the above indicated ratios.

In a specific embodiment, the weight ratio of Tau-fluvalinate to Chromafenozide is from about 1:100 to 100:1. In another embodiment, the weight ratio of Tau-fluvalinate to Chromafenozide is from about 1:50 to 50:1.

In a specific embodiment, the weight ratio of Tau-fluvalinate to Halofenozide is from about 1:100 to 100:1. In another embodiment, the weight ratio of Tau-fluvalinate to Halofenozide is from about 1:50 to 50:1.

In a specific embodiment, the weight ratio of Tau-fluvalinate to Methoxyfenozide is from about 1:100 to 100:1. In another embodiment, the weight ratio of Tau-fluvalinate to Methoxyfenozide is from about 1:50 to 50:1.

In a specific embodiment, the weight ratio of Tau-fluvalinate to Tebufenozide is from about 1:100 to 100:1. In another embodiment, the weight ratio of Tau-fluvalinate to Tebufenozide is from about 1:50 to 50:1.

In one embodiment, the weight ratio of Tau-fluvalinate to Mitochondrial complex III electron transport inhibitor (Qo site) is from about 1:100 to 100:1. In another embodiment, the weight ratio of Tau-fluvalinate to Mitochondrial complex III electron transport inhibitor (Qo site) is from about 1:50 to 50:1. The weight ratio of Tau-fluvalinate to Mitochondrial complex III electron transport inhibitor (Qo site) may be any in-between range selected from the above indicated ratios.

In a specific embodiment, the weight ratio of Tau-fluvalinate to Acequinocyl is from about 1:100 to 100:1. In another embodiment, the weight ratio of Tau-fluvalinate to Acequinocyl is from about 1:50 to 50:1.

In a specific embodiment, the weight ratio of Tau-fluvalinate to Fluacrypyrim is from about 1:100 to 100:1. In another embodiment, the weight ratio of Tau-fluvalinate to Fluacrypyrim is from about 1:50 to 50:1.

In a specific embodiment, the weight ratio of Tau-fluvalinate to Hydramethylnon is from about 1:100 to 100:1. In another embodiment, the weight ratio of Tau-fluvalinate to Hydramethylnon is from about 1:50 to 50:1.

In one embodiment, the weight ratio of Tau-fluvalinate to Cyclotide insecticide is from about 1:100 to 100:1. In another embodiment, the weight ratio of Tau-fluvalinate to Cyclotide insecticide is from about 1:50 to 50:1. The weight ratio of Tau-fluvalinate to Cyclotide insecticide may be any in-between range selected from the above indicated ratios.

In a specific embodiment, the weight ratio of Tau-fluvalinate to Clotoria Ternatea is from about 1:100 to 100:1. In another embodiment, the weight ratio of Tau-fluvalinate to Clotoria Ternatea is from about 1:50 to 50:1.

In one embodiment, the weight ratio of Tau-fluvalinate to Nicotinic acetylcholine receptor (nAChR) allosteric modulator (site II) is from about 1:100 to 100:1. In another embodiment, the weight ratio of Tau-fluvalinate to Nicotinic acetylcholine receptor (nAChR) allosteric modulator (site II) is from about 1:50 to 50:1. The weight ratio of Tau-fluvalinate to Nicotinic acetylcholine receptor (nAChR) allosteric modulator (site II) may be any in-between range selected from the above indicated ratios.

In a specific embodiment, the weight ratio of Tau-fluvalinate to GS-omega/kappa HXTX-Hv1a peptide is from about 1:100 to 100:1. In another embodiment, the weight ratio of Tau-fluvalinate to GS-omega/kappa HXTX-Hv1a peptide is from about 1:50 to 50:1.

In one embodiment, the weight ratio of Tau-fluvalinate to Calcium-activated potassium channel (KCa2) modulator is from about 1:100 to 100:1. In another embodiment, the weight ratio of Tau-fluvalinate to Calcium-activated potassium channel (KCa2) modulator is from about 1:50 to 50:1. The weight ratio of Tau-fluvalinate to Calcium-activated potassium channel (KCa2) modulator may be any in-between range selected from the above indicated ratios.

In a specific embodiment, the weight ratio of Tau-fluvalinate to Acynonapyr is from about 1:100 to 100:1. In another embodiment, the weight ratio of Tau-fluvalinate to Acynonapyr is from about 1:50 to 50:1.

In one embodiment, the weight ratio of Tau-fluvalinate to Insecticide synergist is from about 1:100 to 100:1. In another embodiment, the weight ratio of Tau-fluvalinate to Insecticide synergist is from about 1:50 to 50:1. The weight ratio of Tau-fluvalinate to Insecticide synergist may be any in-between range selected from the above indicated ratios.

In a specific embodiment, the weight ratio of Tau-fluvalinate to N-octyl bicycloheptene dicarboximide (MGK-264) is from about 1:100 to 100:1. In another embodiment, the weight ratio of Tau-fluvalinate to N-octyl bicycloheptene dicarboximide (MGK-264) is from about 1:50 to 50:1.

In a specific embodiment, the weight ratio of Tau-fluvalinate to Piprotal is from about 1:100 to 100:1. In another embodiment, the weight ratio of Tau-fluvalinate to Piprotal is from about 1:50 to 50:1.

In a specific embodiment, the weight ratio of Tau-fluvalinate to Propyl isome is from about 1:100 to 100:1. In another embodiment, the weight ratio of Tau-fluvalinate to Propyl isome is from about 1:50 to 50:1.

In a specific embodiment, the weight ratio of Tau-fluvalinate to Sesamex is from about 1:100 to 100:1. In another embodiment, the weight ratio of Tau-fluvalinate to Sesamex is from about 1:50 to 50:1.

In a specific embodiment, the weight ratio of Tau-fluvalinate to Sesamolin is from about 1:100 to 100:1. In another embodiment, the weight ratio of Tau-fluvalinate to Sesamolin is from about 1:50 to 50:1.

In a specific embodiment, the weight ratio of Tau-fluvalinate to Sulfoxide is from about 1:100 to 100:1. In another embodiment, the weight ratio of Tau-fluvalinate to Sulfoxide is from about 1:50 to 50:1.

In one embodiment, the weight ratio of Tau-fluvalinate to Fungicide is from about 1:100 to 100:1. In another embodiment, the weight ratio of Tau-fluvalinate to Fungicide is from about 1:50 to 50:1. The weight ratio of Tau-fluvalinate to Fungicide may be any in-between range selected from the above indicated ratios.

In a specific embodiment, the weight ratio of Tau-fluvalinate to Pydiflumetofen is from about 1:100 to 100:1. In another embodiment, the weight ratio of Tau-fluvalinate to Pydiflumetofen is from about 1:50 to 50:1.

In a specific embodiment, the weight ratio of Tau-fluvalinate to Fluazinam is from about 1:100 to 100:1. In another embodiment, the weight ratio of Tau-fluvalinate to Fluazinam is from about 1:50 to 50:1.

In a specific embodiment, the weight ratio of Tau-fluvalinate to Fluxapyroxad is from about 1:100 to 100:1. In another embodiment, the weight ratio of Tau-fluvalinate to Fluxapyroxad is from about 1:50 to 50:1.

In a specific embodiment, the weight ratio of Tau-fluvalinate to Difenoconazole is from about 1:100 to 100:1. In another embodiment, the weight ratio of Tau-fluvalinate to Difenoconazole is from about 1:50 to 50:1.

In a specific embodiment, the weight ratio of Tau-fluvalinate to Tebuconazole is from about 1:100 to 100:1. In another embodiment, the weight ratio of Tau-fluvalinate to Tebuconazole is from about 1:50 to 50:1.

In a specific embodiment, the weight ratio of Tau-fluvalinate to Fludioxonil is from about 1:100 to 100:1. In another embodiment, the weight ratio of Tau-fluvalinate to Fludioxonil is from about 1:50 to 50:1.

In a specific embodiment, the weight ratio of Tau-fluvalinate to Azoxystrobin is from about 1:100 to 100:1. In another embodiment, the weight ratio of Tau-fluvalinate to Azoxystrobin is from about 1:50 to 50:1.

In a specific embodiment, the weight ratio of Tau-fluvalinate to Mancozeb is from about 1:100 to 100:1. In another embodiment, the weight ratio of Tau-fluvalinate to Mancozeb is from about 1:50 to 50:1.

In one embodiment, the weight ratio of Tau-fluvalinate to Neonicotinoid insecticide is from about 1:100 to 100:1. In another embodiment, the weight ratio of Tau-fluvalinate to Neonicotinoid insecticide is from about 1:50 to 50:1. The weight ratio of Tau-fluvalinate to Neonicotinoid insecticide may be any in-between range selected from the above indicated ratios.

In a specific embodiment, the weight ratio of Tau-fluvalinate to Cycloxaprid is from about 1:100 to 100:1. In another embodiment, the weight ratio of Tau-fluvalinate to Cycloxaprid is from about 1:50 to 50:1.

In a specific embodiment, the weight ratio of Tau-fluvalinate to Guadipyr is from about 1:100 to 100:1. In another embodiment, the weight ratio of Tau-fluvalinate to Guadipyr is from about 1:50 to 50:1.

In a specific embodiment, the weight ratio of Tau-fluvalinate to Imidaclothiz is from about 1:100 to 100:1. In another embodiment, the weight ratio of Tau-fluvalinate to Imidaclothiz is from about 1:50 to 50:1.

In one embodiment, the weight ratio of Tau-fluvalinate to Acaricide is from about 1:100 to 100:1. In another embodiment, the weight ratio of Tau-fluvalinate to Acaricide is from about 1:50 to 50:1. The weight ratio of Tau-fluvalinate to Acaricide may be any in-between range selected from the above indicated ratios.

In a specific embodiment, the weight ratio of Tau-fluvalinate to Cyflumetofen is from about 1:100 to 100:1. In another embodiment, the weight ratio of Tau-fluvalinate to Cyflumetofen is from about 1:50 to 50:1.

In a specific embodiment, the weight ratio of Tau-fluvalinate to Sila-Cyflumetofen is from about 1:100 to 100:1. In another embodiment, the weight ratio of Tau-fluvalinate to Sila-Cyflumetofen is from about 1:50 to 50:1.

In one embodiment, the weight ratio of Tau-fluvalinate to Diamide insecticide is from about 1:100 to 100:1. In another embodiment, the weight ratio of Tau-fluvalinate to Diamide insecticide is from about 1:50 to 50:1. The weight ratio of Tau-fluvalinate to Diamide insecticide may be any in-between range selected from the above indicated ratios.

In a specific embodiment, the weight ratio of Tau-fluvalinate to Cyproflanilide is from about 1:100 to 100:1. In another embodiment, the weight ratio of Tau-fluvalinate to Cyproflanilide is from about 1:50 to 50:1.

In one embodiment, the weight ratio of Tau-fluvalinate to Mesoionic insecticide is from about 1:100 to 100:1. In another embodiment, the weight ratio of Tau-fluvalinate to Mesoionic insecticide is from about 1:50 to 50:1. The weight ratio of Tau-fluvalinate to Mesoionic insecticide may be any in-between range selected from the above indicated ratios.

In a specific embodiment, the weight ratio of Tau-fluvalinate to Dicloromezotiaz is from about 1:100 to 100:1. In another embodiment, the weight ratio of Tau-fluvalinate to Dicloromezotiaz is from about 1:50 to 50:1.

In a specific embodiment, the weight ratio of Tau-fluvalinate to Fenmezoditiaz is from about 1:100 to 100:1. In another embodiment, the weight ratio of Tau-fluvalinate to Fenmezoditiaz is from about 1:50 to 50:1.

In one embodiment, the weight ratio of Tau-fluvalinate to Pyrazole carboxamide insecticide is from about 1:100 to 100:1. In another embodiment, the weight ratio of Tau-fluvalinate to Pyrazole carboxamide insecticide is from about 1:50 to 50:1. The weight ratio of Tau-fluvalinate to Pyrazole carboxamide insecticide may be any in-between range selected from the above indicated ratios.

In a specific embodiment, the weight ratio of Tau-fluvalinate to Dimpropyridaz is from about 1:100 to 100:1. In another embodiment, the weight ratio of Tau-fluvalinate to Dimpropyridaz is from about 1:50 to 50:1.

In a specific embodiment, the weight ratio of Tau-fluvalinate to Tyclopyrazoflor is from about 1:100 to 100:1. In another embodiment, the weight ratio of Tau-fluvalinate to Tyclopyrazoflor is from about 1:50 to 50:1.

In a specific embodiment, the weight ratio of Tau-fluvalinate to Fluchlordiniliprole is from about 1:100 to 100:1. In another embodiment, the weight ratio of Tau-fluvalinate to Fluchlordiniliprole is from about 1:50 to 50:1.

In one embodiment, the weight ratio of Tau-fluvalinate to Sulfonamide nematicide is from about 1:100 to 100:1. In another embodiment, the weight ratio of Tau-fluvalinate to Sulfonamide nematicide is from about 1:50 to 50:1. The weight ratio of Tau-fluvalinate to Sulfonamide nematicide may be any in-between range selected from the above indicated ratios.

In a specific embodiment, the weight ratio of Tau-fluvalinate to Fluazaindolizine is from about 1:100 to 100:1. In another embodiment, the weight ratio of Tau-fluvalinate to Fluazaindolizine is from about 1:50 to 50:1.

In one embodiment, the weight ratio of Tau-fluvalinate to Phenylpyrazole insecticide is from about 1:100 to 100:1. In another embodiment, the weight ratio of Tau-fluvalinate to Phenylpyrazole insecticide is from about 1:50 to 50:1. The weight ratio of Tau-fluvalinate to Phenylpyrazole insecticide may be any in-between range selected from the above indicated ratios.

In a specific embodiment, the weight ratio of Tau-fluvalinate to Flufiprole is from about 1:100 to 100:1. In another embodiment, the weight ratio of Tau-fluvalinate to Flufiprole is from about 1:50 to 50:1.

In a specific embodiment, the weight ratio of Tau-fluvalinate to Nicofluprole is from about 1:100 to 100:1. In another embodiment, the weight ratio of Tau-fluvalinate to Nicofluprole is from about 1:50 to 50:1.

In a specific embodiment, the weight ratio of Tau-fluvalinate to Pyriprole is from about 1:100 to 100:1. In another embodiment, the weight ratio of Tau-fluvalinate to Pyriprole is from about 1:50 to 50:1.

In one embodiment, the weight ratio of Tau-fluvalinate to Fluorine containing insecticide is from about 1:100 to 100:1. In another embodiment, the weight ratio of Tau-fluvalinate to Fluorine containing insecticide is from about 1:50 to 50:1. The weight ratio of Tau-fluvalinate to Fluorine containing insecticide may be any in-between range selected from the above indicated ratios.

In a specific embodiment, the weight ratio of Tau-fluvalinate to Fluhexafon is from about 1:100 to 100:1. In another embodiment, the weight ratio of Tau-fluvalinate to Fluhexafon is from about 1:50 to 50:1.

In a specific embodiment, the weight ratio of Tau-fluvalinate to Bistrifluron is from about 1:100 to 100:1. In another embodiment, the weight ratio of Tau-fluvalinate to Bistrifluron is from about 1:50 to 50:1.

In a specific embodiment, the weight ratio of Tau-fluvalinate to Trifluenfuronate is from about 1:100 to 100:1. In another embodiment, the weight ratio of Tau-fluvalinate to Trifluenfuronate is from about 1:50 to 50:1.

In one embodiment, the weight ratio of Tau-fluvalinate to Isoxazoline parasiticideis from about 1:100 to 100:1. In another embodiment, the weight ratio of Tau-fluvalinate to Isoxazoline parasiticide is from about 1:50 to 50:1. The weight ratio of Tau-fluvalinate to Isoxazoline parasiticide may be any in-between range selected from the above indicated ratios.

In a specific embodiment, the weight ratio of Tau-fluvalinate to Lotilaner is from about 1:100 to 100:1. In another embodiment, the weight ratio of Tau-fluvalinate to Lotilaner is from about 1:50 to 50:1.

In one embodiment, the weight ratio of Tau-fluvalinate to Indazole insecticide is from about 1:100 to 100:1. In another embodiment, the weight ratio of Tau-fluvalinate to Indazole insecticide is from about 1:50 to 50:1. The weight ratio of Tau-fluvalinate to Indazole insecticide may be any in-between range selected from the above indicated ratios.

In a specific embodiment, the weight ratio of Tau-fluvalinate to Indazapyroxamet is from about 1:100 to 100:1. In another embodiment, the weight ratio of Tau-fluvalinate to Indazapyroxamet is from about 1:50 to 50:1.

In one embodiment, the weight ratio of Tau-fluvalinate to one or more Mineral oil is from about 1:100 to 100:1. In another embodiment, the weight ratio of Tau-fluvalinate to one or more Mineral oil is from about 1:50 to 50:1. The weight ratio of Tau-fluvalinate to one or more Mineral oil may be any in-between range selected from the above indicated ratios.

In a specific embodiment, the weight ratio of Tau-fluvalinate to paraffinic oils is from about 1:100 to 100:1. In another embodiment, the weight ratio of Tau-fluvalinate to paraffinic oils is from about 1:50 to 50:1.

In one embodiment, the weight ratio of Tau-fluvalinate to plant extract is from about 1:100 to 100:1. In another embodiment, the weight ratio of Tau-fluvalinate to plant extract is from about 1:50 to 50:1. The weight ratio of Tau-fluvalinate to plant extract may be any in-between range selected from the above indicated ratios.

In a specific embodiment, the weight ratio of Tau-fluvalinate to Garlic extract is from about 1:100 to 100:1. In another embodiment, the weight ratio of Tau-fluvalinate to Garlic extract is from about 1:50 to 50:1.

In a more specific embodiment, the weight ratio of Tau-fluvalinate to Garlic extract is 1:1.

In a specific embodiment, the weight ratio of Tau-fluvalinate to Neem extract is from about 1:100 to 100:1. In another embodiment, the weight ratio of Tau-fluvalinate to Neem extract is from about 1:50 to 50:1.

In a specific embodiment, the weight ratio of Tau-fluvalinate to Tea tree oil is from about 1:100 to 100:1. In another embodiment, the weight ratio of Tau-fluvalinate to Tea tree oil is from about 1:50 to 50:1.

In a specific embodiment, the weight ratio of Tau-fluvalinate to Eugenol, that is Clove oil is from about 1:100 to 100:1. In another embodiment, the weight ratio of Tau-fluvalinate to Eugenol, that is Clove oil is from about 1:50 to 50:1.

In a specific embodiment, the weight ratio of Tau-fluvalinate to Citronella oil is from about 1:100 to 100:1. In another embodiment, the weight ratio of Tau-fluvalinate to Citronella oil is from about 1:50 to 50:1.

In a specific embodiment, the weight ratio of Tau-fluvalinate to Rose oil is from about 1:100 to 100:1. In another embodiment, the weight ratio of Tau-fluvalinate to Rose oil is from about 1:50 to 50:1.

In a specific embodiment, the weight ratio of Tau-fluvalinate to Palmarosa oil is from about 1:100 to 100:1. In another embodiment, the weight ratio of Tau-fluvalinate to Palmarosa oil is from about 1:50 to 50:1.

In a specific embodiment, the weight ratio of Tau-fluvalinate to Palmarosa oil is from about 1:100 to 100:1. In another embodiment, the weight ratio of Tau-fluvalinate to Geraniol is from about 1:50 to 50:1.

In one embodiment, the weight ratio of Tau-fluvalinate to repellant is from about 1:100 to 100:1. In another embodiment, the weight ratio of Tau-fluvalinate to repellant is from about 1:50 to 50:1. The weight ratio of Tau-fluvalinate to repellant may be any in-between range selected from the above indicated ratios.

In a specific embodiment, the weight ratio of Tau-fluvalinate to Thymol is from about 1:100 to 100:1. In another embodiment, the weight ratio of Tau-fluvalinate to Thymol is from about 1:50 to 50:1.

In a specific embodiment, the weight ratio of Tau-fluvalinate to Citronella is from about 1:100 to 100:1. In another embodiment, the weight ratio of Tau-fluvalinate to Citronella is from about 1:50 to 50:1.

In one embodiment, the weight ratio of Tau-fluvalinate to one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids, is from about 1:100 to 100:1. In another embodiment, the weight ratio of Tau-fluvalinate to the additives is from about 1:50 to 50:1. The weight ratio of Tau-fluvalinate to the additives may be any in-between range selected from the above indicated ratios.

In an embodiment, the mixture combination of the present invention may be applied pre-sowing or post-sowing, pre-emergence, or early-post-emergence of the crop. The mixture combination may be applied via in furrow spray, foliar application, broadcast, basal application, soil application, soil incorporation or soil injection.

In a further embodiment, the mixture combination is applied in non-crop areas which include but are not limited to, commercial areas, residential areas, lawns, ornamental plants, shrubs, trees, parks, livestock areas, warehouses, food storage facilities, grain bins, turfgrass, pastures, grasslands, rangelands, fallow land, rights-of-way, golf courses, parks, along roadsides, power-lines, pipelines, railways, forests, well sites, and equipment yards.

In yet another embodiment, the plants include vegetables, such as tomatoes, peppers, cabbage, broccoli, lettuce, spinach, cauliflower, cucurbits, melon, watermelon, cucumbers, carrots, onions, potatoes, tobacco, pome and stone fruits, walnuts, kiwi, berries, olive, almonds, pineapples, apples, pears, plums, peaches, and cherries, table and wine grapes, citrus fruit, such as oranges, lemons, grapefruits and limes, cotton, soybean, oil seed rape, tree nuts, wheat, barley, maize, sorghum, sunflower, peanuts, rice, pasture, corn, coffee, beans, peas, yucca, sugar cane, clover, chili and ornamentals such as roses.

In further embodiment, the plants include cultivated plants which tolerate the action of herbicides, fungicides or insecticides as a result of breeding and/or genetically engineered methods.

In an embodiment, the insect pests are of the order Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), B. tryoni, Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the insect pests are of the order Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Bactericera cockerelli, Phytocoris spp. (plant bugs), Nysius spp, Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In yet another embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In yet another embodiment, the insect pests are of the order Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Ectomyelois ceratoniae, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruit tree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leaf perforator), Caloptilia spp. (leaf miners), Capua reticulana, Carposina niponensis (peach fruit moth), C. auricilius, Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, S. innotata, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera littoralis (cotton leafworm), Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer), Halyomorpha halys (stink bug), Eriococcus spp, Ulonemia spp and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis, Selenothrips spp, Chaetanaphothrips spp and Thrips spp.

In some embodiments, the insects include but not limited to Spidermites, Halotydeus spp. Tetranychus urticae, Spodoptera littoralis, Spodoptera spp, Helicoverpa spp., Aphis spp., Myzus spp., Bemisia tabaci, Trialurodes vaporariorum, Tuta absoluta, Halyomorpha halys, Drosophila spp., Frankliniella spp., Aphis gossypii, Tetranichus spp., Lygus spp., Bactrocera dorsalis, B. tryoni, Ceratitis spp., Ceratitis capitata, Bactericera cockerelli, Nysius spp, Nilaparvata lugens, Ectomyelois ceratoniae, Amyelosis transitella, C. auricilius, Chilo spp., Cnaphalocerus medinalis, Cydia pomonella, S. innotata, Scirpophaga incertulas, Eriococcus spp, Ulonemia spp, Heliothrips haemorrhaidalis, Selenothrips spp and Chaetanaphothrips spp.

The weight ratio between Tau-fluvalinate and at least one crop protection chemical, compound II, as defined above, varies depending upon various conditions such as the type of the formulation, weather conditions, the type of crop and the type of pests.

In an embodiment, the present invention provides mixture combination comprising a Tau-fluvalinate and one or more active compounds II, as mentioned above, wherein the application rates of the mixture according to the invention are from 1 g/ha to 1000 g/ha. In another embodiment, the application rate of the mixture according to the invention are from 500 g/ha to 1000 g/ha. In another embodiment, the application rate of the mixture according to the invention are from 1 g/ha to 500 g/ha.

In another embodiment, Tau-fluvalinate, and the crop protection chemical compound II, as defined above, can be applied simultaneously, that is jointly or separately, or in succession, the sequence, in the case of separate application, generally not having any effect on the result of the control measures.

That is, each of Tau-fluvalinate, and the crop protection chemical compound II may be applied jointly or in succession. In one example, Tau-fluvalinate, and the crop protection chemical compound II are prepared separately, and the individual formulations are applied as is, or diluted to predetermined concentrations. In a further example, Tau-fluvalinate, and the crop protection chemical compound II are prepared separately, and the formulations are mixed when diluted to a predetermined concentration. In another example, Tau-fluvalinate, and the crop protection chemical compound II are formulated together, and the formulation is applied as it is, or the formulation is diluted to a predetermined concentration.

For example, tau-fluvalinate, and Gamma-cyhalothrin can be applied simultaneously, that is jointly or separately, or in succession, the sequence, in the case of separate application, generally not having any effect on the result of the control measures. In one example, tau-fluvalinate, and Gamma-cyhalothrin are prepared separately, and the individual formulations are applied as is, or diluted to predetermined concentrations. In a further example, tau-fluvalinate, and Gamma-cyhalothrin are prepared separately, and the formulations are mixed when diluted to a predetermined concentration. In another example, tau-fluvalinate, and Gamma-cyhalothrin are formulated together, and the formulation is applied as it is, or the formulation is diluted to a predetermined concentration.

For example, tau-fluvalinate, and Alpha-cypermethrin can be applied simultaneously, that is jointly or separately, or in succession, the sequence, in the case of separate application, generally not having any effect on the result of the control measures. In one example, tau-fluvalinate, and Alpha-cypermethrin are prepared separately, and the individual formulations are applied as is, or diluted to predetermined concentrations. In a further example, tau-fluvalinate, and Alpha-cypermethrin are prepared separately, and the formulations are mixed when diluted to a predetermined concentration. In another example, tau-fluvalinate, and Alpha-cypermethrin are formulated together, and the formulation is applied as it is, or the formulation is diluted to a predetermined concentration.

For example, tau-fluvalinate, and Etofenprox can be applied simultaneously, that is jointly or separately, or in succession, the sequence, in the case of separate application, generally not having any effect on the result of the control measures. In one example, tau-fluvalinate, and Etofenprox are prepared separately, and the individual formulations are applied as is, or diluted to predetermined concentrations. In a further example, tau-fluvalinate, and Etofenprox are prepared separately, and the formulations are mixed when diluted to a predetermined concentration. In another example, tau-fluvalinate, and Etofenprox are formulated together, and the formulation is applied as it is, or the formulation is diluted to a predetermined concentration.

For example, tau-fluvalinate, and Spinosad can be applied simultaneously, that is jointly or separately, or in succession, the sequence, in the case of separate application, generally not having any effect on the result of the control measures. In one example, tau-fluvalinate, and Spinosad are prepared separately, and the individual formulations are applied as is, or diluted to predetermined concentrations. In a further example, tau-fluvalinate, and Spinosad are prepared separately, and the formulations are mixed when diluted to a predetermined concentration. In another example, tau-fluvalinate, and Spinosad are formulated together, and the formulation is applied as it is, or the formulation is diluted to a predetermined concentration.

For example, tau-fluvalinate, and Flupyradifurone can be applied simultaneously, that is jointly or separately, or in succession, the sequence, in the case of separate application, generally not having any effect on the result of the control measures. In one example, tau-fluvalinate, and Flupyradifurone are prepared separately, and the individual formulations are applied as is, or diluted to predetermined concentrations. In a further example, tau-fluvalinate, and Flupyradifurone are prepared separately, and the formulations are mixed when diluted to a predetermined concentration. In another example, tau-fluvalinate, and Flupyradifurone are formulated together, and the formulation is applied as it is, or the formulation is diluted to a predetermined concentration.

For example, tau-fluvalinate, and Flupyrimin can be applied simultaneously, that is jointly or separately, or in succession, the sequence, in the case of separate application, generally not having any effect on the result of the control measures. In one example, tau-fluvalinate, and Flupyrimin are prepared separately, and the individual formulations are applied as is, or diluted to predetermined concentrations. In a further example, tau-fluvalinate, and Flupyrimin are prepared separately, and the formulations are mixed when diluted to a predetermined concentration. In another example, tau-fluvalinate, and Flupyrimin are formulated together, and the formulation is applied as it is, or the formulation is diluted to a predetermined concentration.

For example, tau-fluvalinate, and Triflumezopyrim can be applied simultaneously, that is jointly or separately, or in succession, the sequence, in the case of separate application, generally not having any effect on the result of the control measures. In one example, tau-fluvalinate, and Triflumezopyrim are prepared separately, and the individual formulations are applied as is, or diluted to predetermined concentrations. In a further example, tau-fluvalinate, and Triflumezopyrim are prepared separately, and the formulations are mixed when diluted to a predetermined concentration. In another example, tau-fluvalinate, and Triflumezopyrim are formulated together, and the formulation is applied as it is, or the formulation is diluted to a predetermined concentration.

For example, tau-fluvalinate, and Chlorfenapyr can be applied simultaneously, that is jointly or separately, or in succession, the sequence, in the case of separate application, generally not having any effect on the result of the control measures. In one example, tau-fluvalinate, and Chlorfenapyr are prepared separately, and the individual formulations are applied as is, or diluted to predetermined concentrations. In a further example, tau-fluvalinate, and Chlorfenapyr are prepared separately, and the formulations are mixed when diluted to a predetermined concentration. In another example, tau-fluvalinate, and Chlorfenapyr are formulated together, and the formulation is applied as it is, or the formulation is diluted to a predetermined concentration.

For example, tau-fluvalinate, and Brochlorfenapyr can be applied simultaneously, that is jointly or separately, or in succession, the sequence, in the case of separate application, generally not having any effect on the result of the control measures. In one example, tau-fluvalinate, and Brochlorfenapyr are prepared separately, and the individual formulations are applied as is, or diluted to predetermined concentrations. In a further example, tau-fluvalinate, and Brochlorfenapyr are prepared separately, and the formulations are mixed when diluted to a predetermined concentration. In another example, tau-fluvalinate, and Brochlorfenapyr are formulated together, and the formulation is applied as it is, or the formulation is diluted to a predetermined concentration.

For example, tau-fluvalinate, and Tetrachlorantraniliprole can be applied simultaneously, that is jointly or separately, or in succession, the sequence, in the case of separate application, generally not having any effect on the result of the control measures. In one example, tau-fluvalinate, and Tetrachlorantraniliprole are prepared separately, and the individual formulations are applied as is, or diluted to predetermined concentrations. In a further example, tau-fluvalinate, and Tetrachlorantraniliprole are prepared separately, and the formulations are mixed when diluted to a predetermined concentration. In another example, tau-fluvalinate, and Tetrachlorantraniliprole are formulated together, and the formulation is applied as it is, or the formulation is diluted to a predetermined concentration.

For example, tau-fluvalinate, and Thiotraniliprole can be applied simultaneously, that is jointly or separately, or in succession, the sequence, in the case of separate application, generally not having any effect on the result of the control measures. In one example, tau-fluvalinate, and Thiotraniliprole are prepared separately, and the individual formulations are applied as is, or diluted to predetermined concentrations. In a further example, tau-fluvalinate, and Thiotraniliprole are prepared separately, and the formulations are mixed when diluted to a predetermined concentration. In another example, tau-fluvalinate, and Thiotraniliprole are formulated together, and the formulation is applied as it is, or the formulation is diluted to a predetermined concentration.

For example, tau-fluvalinate, and Bensultap can be applied simultaneously, that is jointly or separately, or in succession, the sequence, in the case of separate application, generally not having any effect on the result of the control measures. In one example, tau-fluvalinate, and Bensultap are prepared separately, and the individual formulations are applied as is, or diluted to predetermined concentrations. In a further example, tau-fluvalinate, and Bensultap are prepared separately, and the formulations are mixed when diluted to a predetermined concentration. In another example, tau-fluvalinate, and Bensultap are formulated together, and the formulation is applied as it is, or the formulation is diluted to a predetermined concentration.

For example, tau-fluvalinate, and Cartap hydrochloride can be applied simultaneously, that is jointly or separately, or in succession, the sequence, in the case of separate application, generally not having any effect on the result of the control measures. In one example, tau-fluvalinate, and Cartap hydrochloride are prepared separately, and the individual formulations are applied as is, or diluted to predetermined concentrations. In a further example, tau-fluvalinate, and Cartap hydrochloride are prepared separately, and the formulations are mixed when diluted to a predetermined concentration. In another example, tau-fluvalinate, and Cartap hydrochloride are formulated together, and the formulation is applied as it is, or the formulation is diluted to a predetermined concentration.

For example, tau-fluvalinate, and Thiocyclam can be applied simultaneously, that is jointly or separately, or in succession, the sequence, in the case of separate application, generally not having any effect on the result of the control measures. In one example, tau-fluvalinate, and Thiocyclam are prepared separately, and the individual formulations are applied as is, or diluted to predetermined concentrations. In a further example, tau-fluvalinate, and Thiocyclam are prepared separately, and the formulations are mixed when diluted to a predetermined concentration. In another example, tau-fluvalinate, and Thiocyclam are formulated together, and the formulation is applied as it is, or the formulation is diluted to a predetermined concentration.

For example, tau-fluvalinate, and Thisultap-sodium can be applied simultaneously, that is jointly or separately, or in succession, the sequence, in the case of separate application, generally not having any effect on the result of the control measures. In one example, tau-fluvalinate, and Thisultap-sodium are prepared separately, and the individual formulations are applied as is, or diluted to predetermined concentrations. In a further example, tau-fluvalinate, and Thisultap-sodium are prepared separately, and the formulations are mixed when diluted to a predetermined concentration. In another example, tau-fluvalinate, and Thisultap-sodium are formulated together, and the formulation is applied as it is, or the formulation is diluted to a predetermined concentration.

For example, tau-fluvalinate, and Fenazaquin can be applied simultaneously, that is jointly or separately, or in succession, the sequence, in the case of separate application, generally not having any effect on the result of the control measures. In one example, tau-fluvalinate, and Fenazaquin are prepared separately, and the individual formulations are applied as is, or diluted to predetermined concentrations. In a further example, tau-fluvalinate, and Fenazaquin are prepared separately, and the formulations are mixed when diluted to a predetermined concentration. In another example, tau-fluvalinate, and Fenazaquin are formulated together, and the formulation is applied as it is, or the formulation is diluted to a predetermined concentration.

For example, tau-fluvalinate, and Pyridaben can be applied simultaneously, that is jointly or separately, or in succession, the sequence, in the case of separate application, generally not having any effect on the result of the control measures. In one example, tau-fluvalinate, and Pyridaben are prepared separately, and the individual formulations are applied as is, or diluted to predetermined concentrations. In a further example, tau-fluvalinate, and Pyridaben are prepared separately, and the formulations are mixed when diluted to a predetermined concentration. In another example, tau-fluvalinate, and Pyridaben are formulated together, and the formulation is applied as it is, or the formulation is diluted to a predetermined concentration.

For example, tau-fluvalinate, and Pyrimidifen can be applied simultaneously, that is jointly or separately, or in succession, the sequence, in the case of separate application, generally not having any effect on the result of the control measures. In one example, tau-fluvalinate, and Pyrimidifen are prepared separately, and the individual formulations are applied as is, or diluted to predetermined concentrations. In a further example, tau-fluvalinate, and Pyrimidifen are prepared separately, and the formulations are mixed when diluted to a predetermined concentration. In another example, tau-fluvalinate, and Pyrimidifen are formulated together, and the formulation is applied as it is, or the formulation is diluted to a predetermined concentration.

For example, tau-fluvalinate, and Tebufenpyrad can be applied simultaneously, that is jointly or separately, or in succession, the sequence, in the case of separate application, generally not having any effect on the result of the control measures. In one example, tau-fluvalinate, and Tebufenpyrad are prepared separately, and the individual formulations are applied as is, or diluted to predetermined concentrations. In a further example, tau-fluvalinate, and Tebufenpyrad are prepared separately, and the formulations are mixed when diluted to a predetermined concentration. In another example, tau-fluvalinate, and Tebufenpyrad are formulated together, and the formulation is applied as it is, or the formulation is diluted to a predetermined concentration.

For example, tau-fluvalinate, and Cyetpyrafen can be applied simultaneously, that is jointly or separately, or in succession, the sequence, in the case of separate application, generally not having any effect on the result of the control measures. In one example, tau-fluvalinate, and Cyetpyrafen are prepared separately, and the individual formulations are applied as is, or diluted to predetermined concentrations. In a further example, tau-fluvalinate, and Cyetpyrafen are prepared separately, and the formulations are mixed when diluted to a predetermined concentration. In another example, tau-fluvalinate, and Cyetpyrafen are formulated together, and the formulation is applied as it is, or the formulation is diluted to a predetermined concentration.

For example, tau-fluvalinate, and Fluxametamide can be applied simultaneously, that is jointly or separately, or in succession, the sequence, in the case of separate application, generally not having any effect on the result of the control measures. In one example, tau-fluvalinate, and Fluxametamide are prepared separately, and the individual formulations are applied as is, or diluted to predetermined concentrations. In a further example, tau-fluvalinate, and Fluxametamide are prepared separately, and the formulations are mixed when diluted to a predetermined concentration. In another example, tau-fluvalinate, and Fluxametamide are formulated together, and the formulation is applied as it is, or the formulation is diluted to a predetermined concentration.

For example, tau-fluvalinate, and Isocycloseram can be applied simultaneously, that is jointly or separately, or in succession, the sequence, in the case of separate application, generally not having any effect on the result of the control measures. In one example, tau-fluvalinate, and Isocycloseram are prepared separately, and the individual formulations are applied as is, or diluted to predetermined concentrations. In a further example, tau-fluvalinate, and Isocycloseram are prepared separately, and the formulations are mixed when diluted to a predetermined concentration. In another example, tau-fluvalinate, and Isocycloseram are formulated together, and the formulation is applied as it is, or the formulation is diluted to a predetermined concentration.

For example, tau-fluvalinate, and Fenoxycarb can be applied simultaneously, that is jointly or separately, or in succession, the sequence, in the case of separate application, generally not having any effect on the result of the control measures. In one example, tau-fluvalinate, and Fenoxycarb are prepared separately, and the individual formulations are applied as is, or diluted to predetermined concentrations. In a further example, tau-fluvalinate, and Fenoxycarb are prepared separately, and the formulations are mixed when diluted to a predetermined concentration. In another example, tau-fluvalinate, and Fenoxycarb are formulated together, and the formulation is applied as it is, or the formulation is diluted to a predetermined concentration.

For example, tau-fluvalinate, and Milbemectin can be applied simultaneously, that is jointly or separately, or in succession, the sequence, in the case of separate application, generally not having any effect on the result of the control measures. In one example, tau-fluvalinate, and Milbemectin are prepared separately, and the individual formulations are applied as is, or diluted to predetermined concentrations. In a further example, tau-fluvalinate, and Milbemectin are prepared separately, and the formulations are mixed when diluted to a predetermined concentration. In another example, tau-fluvalinate, and Milbemectin are formulated together, and the formulation is applied as it is, or the formulation is diluted to a predetermined concentration.

For example, tau-fluvalinate, and Lepimectin can be applied simultaneously, that is jointly or separately, or in succession, the sequence, in the case of separate application, generally not having any effect on the result of the control measures. In one example, tau-fluvalinate, and Lepimectin are prepared separately, and the individual formulations are applied as is, or diluted to predetermined concentrations. In a further example, tau-fluvalinate, and Lepimectin are prepared separately, and the formulations are mixed when diluted to a predetermined concentration. In another example, tau-fluvalinate, and Lepimectin are formulated together, and the formulation is applied as it is, or the formulation is diluted to a predetermined concentration.

For example, tau-fluvalinate, and Metaflumizone can be applied simultaneously, that is jointly or separately, or in succession, the sequence, in the case of separate application, generally not having any effect on the result of the control measures. In one example, tau-fluvalinate, and Metaflumizone are prepared separately, and the individual formulations are applied as is, or diluted to predetermined concentrations. In a further example, tau-fluvalinate, and Metaflumizone are prepared separately, and the formulations are mixed when diluted to a predetermined concentration. In another example, tau-fluvalinate, and Metaflumizone are formulated together, and the formulation is applied as it is, or the formulation is diluted to a predetermined concentration.

For example, tau-fluvalinate, and Diflubenzuron can be applied simultaneously, that is jointly or separately, or in succession, the sequence, in the case of separate application, generally not having any effect on the result of the control measures. In one example, tau-fluvalinate, and Diflubenzuron are prepared separately, and the individual formulations are applied as is, or diluted to predetermined concentrations. In a further example, tau-fluvalinate, and Diflubenzuron are prepared separately, and the formulations are mixed when diluted to a predetermined concentration. In another example, tau-fluvalinate, and Diflubenzuron are formulated together, and the formulation is applied as it is, or the formulation is diluted to a predetermined concentration.

For example, tau-fluvalinate, and Flufenoxuron can be applied simultaneously, that is jointly or separately, or in succession, the sequence, in the case of separate application, generally not having any effect on the result of the control measures. In one example, tau-fluvalinate, and Flufenoxuron are prepared separately, and the individual formulations are applied as is, or diluted to predetermined concentrations. In a further example, tau-fluvalinate, and Flufenoxuron are prepared separately, and the formulations are mixed when diluted to a predetermined concentration. In another example, tau-fluvalinate, and Flufenoxuron are formulated together, and the formulation is applied as it is, or the formulation is diluted to a predetermined concentration.

For example, tau-fluvalinate, and Lufenuron can be applied simultaneously, that is jointly or separately, or in succession, the sequence, in the case of separate application, generally not having any effect on the result of the control measures. In one example, tau-fluvalinate, and Lufenuron are prepared separately, and the individual formulations are applied as is, or diluted to predetermined concentrations. In a further example, tau-fluvalinate, and Lufenuron are prepared separately, and the formulations are mixed when diluted to a predetermined concentration. In another example, tau-fluvalinate, and Lufenuron are formulated together, and the formulation is applied as it is, or the formulation is diluted to a predetermined concentration.

For example, tau-fluvalinate, and Teflubenzuron can be applied simultaneously, that is jointly or separately, or in succession, the sequence, in the case of separate application, generally not having any effect on the result of the control measures. In one example, tau-fluvalinate, and Teflubenzuron are prepared separately, and the individual formulations are applied as is, or diluted to predetermined concentrations. In a further example, tau-fluvalinate, and Teflubenzuron are prepared separately, and the formulations are mixed when diluted to a predetermined concentration. In another example, tau-fluvalinate, and Teflubenzuron are formulated together, and the formulation is applied as it is, or the formulation is diluted to a predetermined concentration.

For example, tau-fluvalinate, and Chlorfluazuron can be applied simultaneously, that is jointly or separately, or in succession, the sequence, in the case of separate application, generally not having any effect on the result of the control measures. In one example, tau-fluvalinate, and Chlorfluazuron are prepared separately, and the individual formulations are applied as is, or diluted to predetermined concentrations. In a further example, tau-fluvalinate, and Chlorfluazuron are prepared separately, and the formulations are mixed when diluted to a predetermined concentration. In another example, tau-fluvalinate, and Chlorfluazuron are formulated together, and the formulation is applied as it is, or the formulation is diluted to a predetermined concentration.

For example, tau-fluvalinate, and Spidoxamat can be applied simultaneously, that is jointly or separately, or in succession, the sequence, in the case of separate application, generally not having any effect on the result of the control measures. In one example, tau-fluvalinate, and Spidoxamat are prepared separately, and the individual formulations are applied as is, or diluted to predetermined concentrations. In a further example, tau-fluvalinate, and Spidoxamat are prepared separately, and the formulations are mixed when diluted to a predetermined concentration. In another example, tau-fluvalinate, and Spidoxamat are formulated together, and the formulation is applied as it is, or the formulation is diluted to a predetermined concentration.

For example, tau-fluvalinate, and Spirodiclofen can be applied simultaneously, that is jointly or separately, or in succession, the sequence, in the case of separate application, generally not having any effect on the result of the control measures. In one example, tau-fluvalinate, and Spirodiclofen are prepared separately, and the individual formulations are applied as is, or diluted to predetermined concentrations. In a further example, tau-fluvalinate, and Spirodiclofen are prepared separately, and the formulations are mixed when diluted to a predetermined concentration. In another example, tau-fluvalinate, and Spirodiclofen are formulated together, and the formulation is applied as it is, or the formulation is diluted to a predetermined concentration.

For example, tau-fluvalinate, and Spiromesifen can be applied simultaneously, that is jointly or separately, or in succession, the sequence, in the case of separate application, generally not having any effect on the result of the control measures. In one example, tau-fluvalinate, and Spiromesifen are prepared separately, and the individual formulations are applied as is, or diluted to predetermined concentrations. In a further example, tau-fluvalinate, and Spiromesifen are prepared separately, and the formulations are mixed when diluted to a predetermined concentration. In another example, tau-fluvalinate, and Spiromesifen are formulated together, and the formulation is applied as it is, or the formulation is diluted to a predetermined concentration.

For example, tau-fluvalinate, and Beauveria spp can be applied simultaneously, that is jointly or separately, or in succession, the sequence, in the case of separate application, generally not having any effect on the result of the control measures. In one example, tau-fluvalinate, and Beauveria spp are prepared separately, and the individual formulations are applied as is, or diluted to predetermined concentrations. In a further example, tau-fluvalinate, and Beauveria spp are prepared separately, and the formulations are mixed when diluted to a predetermined concentration. In another example, tau-fluvalinate, and Beauveria spp are formulated together, and the formulation is applied as it is, or the formulation is diluted to a predetermined concentration.

For example, tau-fluvalinate, and Metarhizium spp can be applied simultaneously, that is jointly or separately, or in succession, the sequence, in the case of separate application, generally not having any effect on the result of the control measures. In one example, tau-fluvalinate, and Metarhizium spp are prepared separately, and the individual formulations are applied as is, or diluted to predetermined concentrations. In a further example, tau-fluvalinate, and Metarhizium spp are prepared separately, and the formulations are mixed when diluted to a predetermined concentration. In another example, tau-fluvalinate, and Metarhizium spp are formulated together, and the formulation is applied as it is, or the formulation is diluted to a predetermined concentration.

For example, tau-fluvalinate, and Paecilomyces spp can be applied simultaneously, that is jointly or separately, or in succession, the sequence, in the case of separate application, generally not having any effect on the result of the control measures. In one example, tau-fluvalinate, and Paecilomyces spp are prepared separately, and the individual formulations are applied as is, or diluted to predetermined concentrations. In a further example, tau-fluvalinate, and Paecilomyces spp are prepared separately, and the formulations are mixed when diluted to a predetermined concentration. In another example, tau-fluvalinate, and Paecilomyces spp are formulated together, and the formulation is applied as it is, or the formulation is diluted to a predetermined concentration.

For example, tau-fluvalinate, and Cydia pomonella GV can be applied simultaneously, that is jointly or separately, or in succession, the sequence, in the case of separate application, generally not having any effect on the result of the control measures. In one example, tau-fluvalinate, and Cydia pomonella GV are prepared separately, and the individual formulations are applied as is, or diluted to predetermined concentrations. In a further example, tau-fluvalinate, and Cydia pomonella GV are prepared separately, and the formulations are mixed when diluted to a predetermined concentration. In another example, tau-fluvalinate, and Cydia pomonella GV are formulated together, and the formulation is applied as it is, or the formulation is diluted to a predetermined concentration.

For example, tau-fluvalinate, and Thaumatotibia leucotreta GV can be applied simultaneously, that is jointly or separately, or in succession, the sequence, in the case of separate application, generally not having any effect on the result of the control measures. In one example, tau-fluvalinate, and Thaumatotibia leucotreta GV are prepared separately, and the individual formulations are applied as is, or diluted to predetermined concentrations. In a further example, tau-fluvalinate, and Thaumatotibia leucotreta GV are prepared separately, and the formulations are mixed when diluted to a predetermined concentration. In another example, tau-fluvalinate, and Thaumatotibia leucotreta GV are formulated together, and the formulation is applied as it is, or the formulation is diluted to a predetermined concentration.

For example, tau-fluvalinate, and Anticarsia gemmatalis MNPV can be applied simultaneously, that is jointly or separately, or in succession, the sequence, in the case of separate application, generally not having any effect on the result of the control measures. In one example, tau-fluvalinate, and Anticarsia gemmatalis MNPV are prepared separately, and the individual formulations are applied as is, or diluted to predetermined concentrations. In a further example, tau-fluvalinate, and Anticarsia gemmatalis MNPV are prepared separately, and the formulations are mixed when diluted to a predetermined concentration. In another example, tau-fluvalinate, and Anticarsia gemmatalis MNPV are formulated together, and the formulation is applied as it is, or the formulation is diluted to a predetermined concentration.

For example, tau-fluvalinate, and Helicoverpa armigera NPV can be applied simultaneously, that is jointly or separately, or in succession, the sequence, in the case of separate application, generally not having any effect on the result of the control measures. In one example, tau-fluvalinate, and Helicoverpa armigera NPV are prepared separately, and the individual formulations are applied as is, or diluted to predetermined concentrations. In a further example, tau-fluvalinate, and Helicoverpa armigera NPV are prepared separately, and the formulations are mixed when diluted to a predetermined concentration. In another example, tau-fluvalinate, and Helicoverpa armigera NPV are formulated together, and the formulation is applied as it is, or the formulation is diluted to a predetermined concentration.

For example, tau-fluvalinate, and Flometoquin can be applied simultaneously, that is jointly or separately, or in succession, the sequence, in the case of separate application, generally not having any effect on the result of the control measures. In one example, tau-fluvalinate, and Flometoquin are prepared separately, and the individual formulations are applied as is, or diluted to predetermined concentrations. In a further example, tau-fluvalinate, and Flometoquin are prepared separately, and the formulations are mixed when diluted to a predetermined concentration. In another example, tau-fluvalinate, and Flometoquin are formulated together, and the formulation is applied as it is, or the formulation is diluted to a predetermined concentration.

For example, tau-fluvalinate, and Buprofezin can be applied simultaneously, that is jointly or separately, or in succession, the sequence, in the case of separate application, generally not having any effect on the result of the control measures. In one example, tau-fluvalinate, and Buprofezin are prepared separately, and the individual formulations are applied as is, or diluted to predetermined concentrations. In a further example, tau-fluvalinate, and Buprofezin are prepared separately, and the formulations are mixed when diluted to a predetermined concentration. In another example, tau-fluvalinate, and Buprofezin are formulated together, and the formulation is applied as it is, or the formulation is diluted to a predetermined concentration.

For example, tau-fluvalinate, and Chromafenozide can be applied simultaneously, that is jointly or separately, or in succession, the sequence, in the case of separate application, generally not having any effect on the result of the control measures. In one example, tau-fluvalinate, and Chromafenozide are prepared separately, and the individual formulations are applied as is, or diluted to predetermined concentrations. In a further example, tau-fluvalinate, and Chromafenozide are prepared separately, and the formulations are mixed when diluted to a predetermined concentration. In another example, tau-fluvalinate, and Chromafenozide are formulated together, and the formulation is applied as it is, or the formulation is diluted to a predetermined concentration.

For example, tau-fluvalinate, and Halofenozide can be applied simultaneously, that is jointly or separately, or in succession, the sequence, in the case of separate application, generally not having any effect on the result of the control measures. In one example, tau-fluvalinate, and Halofenozide are prepared separately, and the individual formulations are applied as is, or diluted to predetermined concentrations. In a further example, tau-fluvalinate, and Halofenozide are prepared separately, and the formulations are mixed when diluted to a predetermined concentration. In another example, tau-fluvalinate, and Halofenozide are formulated together, and the formulation is applied as it is, or the formulation is diluted to a predetermined concentration.

For example, tau-fluvalinate, and Methoxyfenozide can be applied simultaneously, that is jointly or separately, or in succession, the sequence, in the case of separate application, generally not having any effect on the result of the control measures. In one example, tau-fluvalinate, and Methoxyfenozide are prepared separately, and the individual formulations are applied as is, or diluted to predetermined concentrations. In a further example, tau-fluvalinate, and Methoxyfenozide are prepared separately, and the formulations are mixed when diluted to a predetermined concentration. In another example, tau-fluvalinate, and Methoxyfenozide are formulated together, and the formulation is applied as it is, or the formulation is diluted to a predetermined concentration.

For example, tau-fluvalinate, and Tebufenozide can be applied simultaneously, that is jointly or separately, or in succession, the sequence, in the case of separate application, generally not having any effect on the result of the control measures. In one example, tau-fluvalinate, and Tebufenozide are prepared separately, and the individual formulations are applied as is, or diluted to predetermined concentrations. In a further example, tau-fluvalinate, and Tebufenozide are prepared separately, and the formulations are mixed when diluted to a predetermined concentration. In another example, tau-fluvalinate, and Tebufenozide are formulated together, and the formulation is applied as it is, or the formulation is diluted to a predetermined concentration.

For example, tau-fluvalinate, and Acequinocyl can be applied simultaneously, that is jointly or separately, or in succession, the sequence, in the case of separate application, generally not having any effect on the result of the control measures. In one example, tau-fluvalinate, and Acequinocyl are prepared separately, and the individual formulations are applied as is, or diluted to predetermined concentrations. In a further example, tau-fluvalinate, and Acequinocyl are prepared separately, and the formulations are mixed when diluted to a predetermined concentration. In another example, tau-fluvalinate and Acequinocyl are formulated together, and the formulation is applied as it is, or the formulation is diluted to a predetermined concentration.

For example, tau-fluvalinate, and Fluacrypyrim can be applied simultaneously, that is jointly or separately, or in succession, the sequence, in the case of separate application, generally not having any effect on the result of the control measures. In one example, tau-fluvalinate, and Fluacrypyrim are prepared separately, and the individual formulations are applied as is, or diluted to predetermined concentrations. In a further example, tau-fluvalinate, and Fluacrypyrim are prepared separately, and the formulations are mixed when diluted to a predetermined concentration. In another example, tau-fluvalinate and Fluacrypyrim are formulated together, and the formulation is applied as it is, or the formulation is diluted to a predetermined concentration.

For example, tau-fluvalinate, and Hydramethylnon can be applied simultaneously, that is jointly or separately, or in succession, the sequence, in the case of separate application, generally not having any effect on the result of the control measures. In one example, tau-fluvalinate, and Hydramethylnon are prepared separately, and the individual formulations are applied as is, or diluted to predetermined concentrations. In a further example, tau-fluvalinate, and Hydramethylnon are prepared separately, and the formulations are mixed when diluted to a predetermined concentration. In another example, tau-fluvalinate and Hydramethylnon are formulated together, and the formulation is applied as it is, or the formulation is diluted to a predetermined concentration.

For example, tau-fluvalinate, and Clotoria Ternatea can be applied simultaneously, that is jointly or separately, or in succession, the sequence, in the case of separate application, generally not having any effect on the result of the control measures. In one example, tau-fluvalinate, and Clotoria Ternatea are prepared separately, and the individual formulations are applied as is, or diluted to predetermined concentrations. In a further example, tau-fluvalinate, and Clotoria Ternatea are prepared separately, and the formulations are mixed when diluted to a predetermined concentration. In another example, tau-fluvalinate and Clotoria Ternatea are formulated together, and the formulation is applied as it is, or the formulation is diluted to a predetermined concentration.

For example, tau-fluvalinate, and GS-omega/kappa HXTX-Hv1a peptide can be applied simultaneously, that is jointly or separately, or in succession, the sequence, in the case of separate application, generally not having any effect on the result of the control measures. In one example, tau-fluvalinate, and GS-omega/kappa HXTX-Hv1a peptide are prepared separately, and the individual formulations are applied as is, or diluted to predetermined concentrations. In a further example, tau-fluvalinate, and GS-omega/kappa HXTX-Hv1a peptide are prepared separately, and the formulations are mixed when diluted to a predetermined concentration. In another example, tau-fluvalinate and GS-omega/kappa HXTX-Hv1a peptide are formulated together, and the formulation is applied as it is, or the formulation is diluted to a predetermined concentration.

For example, tau-fluvalinate, and Acynonapyr can be applied simultaneously, that is jointly or separately, or in succession, the sequence, in the case of separate application, generally not having any effect on the result of the control measures. In one example, tau-fluvalinate, and Acynonapyr are prepared separately, and the individual formulations are applied as is, or diluted to predetermined concentrations. In a further example, tau-fluvalinate, and Acynonapyr are prepared separately, and the formulations are mixed when diluted to a predetermined concentration. In another example, tau-fluvalinate and Acynonapyr are formulated together, and the formulation is applied as it is, or the formulation is diluted to a predetermined concentration.

For example, tau-fluvalinate, and N-octyl bicycloheptene dicarboximide (MGK-264) can be applied simultaneously, that is jointly or separately, or in succession, the sequence, in the case of separate application, generally not having any effect on the result of the control measures. In one example, tau-fluvalinate, and N-octyl bicycloheptene dicarboximide (MGK-264) are prepared separately, and the individual formulations are applied as is, or diluted to predetermined concentrations. In a further example, tau-fluvalinate, and N-octyl bicycloheptene dicarboximide (MGK-264) are prepared separately, and the formulations are mixed when diluted to a predetermined concentration. In another example, tau-fluvalinate and N-octyl bicycloheptene dicarboximide (MGK-264) are formulated together, and the formulation is applied as it is, or the formulation is diluted to a predetermined concentration.

For example, tau-fluvalinate, and Piprotal can be applied simultaneously, that is jointly or separately, or in succession, the sequence, in the case of separate application, generally not having any effect on the result of the control measures. In one example, tau-fluvalinate, and Piprotal are prepared separately, and the individual formulations are applied as is, or diluted to predetermined concentrations. In a further example, tau-fluvalinate, and Piprotal are prepared separately, and the formulations are mixed when diluted to a predetermined concentration. In another example, tau-fluvalinate and Piprotal are formulated together, and the formulation is applied as it is, or the formulation is diluted to a predetermined concentration.

For example, tau-fluvalinate, and Propyl isome can be applied simultaneously, that is jointly or separately, or in succession, the sequence, in the case of separate application, generally not having any effect on the result of the control measures. In one example, tau-fluvalinate, and Propyl isomeare prepared separately, and the individual formulations are applied as is, or diluted to predetermined concentrations. In a further example, tau-fluvalinate, and Propyl isome are prepared separately, and the formulations are mixed when diluted to a predetermined concentration. In another example, tau-fluvalinate and Propyl isome are formulated together, and the formulation is applied as it is, or the formulation is diluted to a predetermined concentration.

For example, tau-fluvalinate, and Sesamex can be applied simultaneously, that is jointly or separately, or in succession, the sequence, in the case of separate application, generally not having any effect on the result of the control measures. In one example, tau-fluvalinate, and Sesamex prepared separately, and the individual formulations are applied as is, or diluted to predetermined concentrations. In a further example, tau-fluvalinate, and Sesamex are prepared separately, and the formulations are mixed when diluted to a predetermined concentration. In another example, tau-fluvalinate and Sesamex are formulated together, and the formulation is applied as it is, or the formulation is diluted to a predetermined concentration.

For example, tau-fluvalinate, and Sesamolin can be applied simultaneously, that is jointly or separately, or in succession, the sequence, in the case of separate application, generally not having any effect on the result of the control measures. In one example, tau-fluvalinate, and Sesamolin prepared separately, and the individual formulations are applied as is, or diluted to predetermined concentrations. In a further example, tau-fluvalinate, and Sesamolin are prepared separately, and the formulations are mixed when diluted to a predetermined concentration. In another example, tau-fluvalinate and Sesamolin are formulated together, and the formulation is applied as it is, or the formulation is diluted to a predetermined concentration.

For example, tau-fluvalinate, and Sulfoxide can be applied simultaneously, that is jointly or separately, or in succession, the sequence, in the case of separate application, generally not having any effect on the result of the control measures. In one example, tau-fluvalinate, and Sulfoxide prepared separately, and the individual formulations are applied as is, or diluted to predetermined concentrations. In a further example, tau-fluvalinate, and Sulfoxide are prepared separately, and the formulations are mixed when diluted to a predetermined concentration. In another example, tau-fluvalinate and Sulfoxide are formulated together, and the formulation is applied as it is, or the formulation is diluted to a predetermined concentration.

For example, tau-fluvalinate, and Pydiflumetofen can be applied simultaneously, that is jointly or separately, or in succession, the sequence, in the case of separate application, generally not having any effect on the result of the control measures. In one example, tau-fluvalinate, and Pydiflumetofen prepared separately, and the individual formulations are applied as is, or diluted to predetermined concentrations. In a further example, tau-fluvalinate, and Pydiflumetofen are prepared separately, and the formulations are mixed when diluted to a predetermined concentration. In another example, tau-fluvalinate and Pydiflumetofen are formulated together, and the formulation is applied as it is, or the formulation is diluted to a predetermined concentration.

For example, tau-fluvalinate, and Fluazinam can be applied simultaneously, that is jointly or separately, or in succession, the sequence, in the case of separate application, generally not having any effect on the result of the control measures. In one example, tau-fluvalinate, and Fluazinam prepared separately, and the individual formulations are applied as is, or diluted to predetermined concentrations. In a further example, tau-fluvalinate, and Fluazinam are prepared separately, and the formulations are mixed when diluted to a predetermined concentration. In another example, tau-fluvalinate and Fluazinam are formulated together, and the formulation is applied as it is, or the formulation is diluted to a predetermined concentration.

For example, tau-fluvalinate, and Fluxapyroxad can be applied simultaneously, that is jointly or separately, or in succession, the sequence, in the case of separate application, generally not having any effect on the result of the control measures. In one example, tau-fluvalinate, and Fluxapyroxad prepared separately, and the individual formulations are applied as is, or diluted to predetermined concentrations. In a further example, tau-fluvalinate, and Fluxapyroxad are prepared separately, and the formulations are mixed when diluted to a predetermined concentration. In another example, tau-fluvalinate and Fluxapyroxad are formulated together, and the formulation is applied as it is, or the formulation is diluted to a predetermined concentration.

For example, tau-fluvalinate, and Difenoconazole can be applied simultaneously, that is jointly or separately, or in succession, the sequence, in the case of separate application, generally not having any effect on the result of the control measures. In one example, tau-fluvalinate, and Difenoconazole prepared separately, and the individual formulations are applied as is, or diluted to predetermined concentrations. In a further example, tau-fluvalinate, and Difenoconazole are prepared separately, and the formulations are mixed when diluted to a predetermined concentration. In another example, tau-fluvalinate and Difenoconazole are formulated together, and the formulation is applied as it is, or the formulation is diluted to a predetermined concentration.

For example, tau-fluvalinate, and Tebuconazole can be applied simultaneously, that is jointly or separately, or in succession, the sequence, in the case of separate application, generally not having any effect on the result of the control measures. In one example, tau-fluvalinate, and Tebuconazole prepared separately, and the individual formulations are applied as is, or diluted to predetermined concentrations. In a further example, tau-fluvalinate, and Tebuconazole are prepared separately, and the formulations are mixed when diluted to a predetermined concentration. In another example, tau-fluvalinate and Tebuconazole are formulated together, and the formulation is applied as it is, or the formulation is diluted to a predetermined concentration.

For example, tau-fluvalinate, and Fludioxonil can be applied simultaneously, that is jointly or separately, or in succession, the sequence, in the case of separate application, generally not having any effect on the result of the control measures. In one example, tau-fluvalinate, and Fludioxonil prepared separately, and the individual formulations are applied as is, or diluted to predetermined concentrations. In a further example, tau-fluvalinate, and Fludioxonil are prepared separately, and the formulations are mixed when diluted to a predetermined concentration. In another example, tau-fluvalinate and Fludioxonil are formulated together, and the formulation is applied as it is, or the formulation is diluted to a predetermined concentration.

For example, tau-fluvalinate, and Azoxystrobin can be applied simultaneously, that is jointly or separately, or in succession, the sequence, in the case of separate application, generally not having any effect on the result of the control measures. In one example, tau-fluvalinate, and Azoxystrobin prepared separately, and the individual formulations are applied as is, or diluted to predetermined concentrations. In a further example, tau-fluvalinate, and Azoxystrobin are prepared separately, and the formulations are mixed when diluted to a predetermined concentration. In another example, tau-fluvalinate and Azoxystrobin are formulated together, and the formulation is applied as it is, or the formulation is diluted to a predetermined concentration.

For example, tau-fluvalinate, and Mancozeb can be applied simultaneously, that is jointly or separately, or in succession, the sequence, in the case of separate application, generally not having any effect on the result of the control measures. In one example, tau-fluvalinate, and Mancozeb prepared separately, and the individual formulations are applied as is, or diluted to predetermined concentrations. In a further example, tau-fluvalinate, and Mancozeb are prepared separately, and the formulations are mixed when diluted to a predetermined concentration. In another example, tau-fluvalinate and Mancozeb are formulated together, and the formulation is applied as it is, or the formulation is diluted to a predetermined concentration.

For example, tau-fluvalinate, and Cycloxaprid can be applied simultaneously, that is jointly or separately, or in succession, the sequence, in the case of separate application, generally not having any effect on the result of the control measures. In one example, tau-fluvalinate, and Cycloxaprid prepared separately, and the individual formulations are applied as is, or diluted to predetermined concentrations. In a further example, tau-fluvalinate, and Cycloxaprid are prepared separately, and the formulations are mixed when diluted to a predetermined concentration. In another example, tau-fluvalinate and Cycloxaprid are formulated together, and the formulation is applied as it is, or the formulation is diluted to a predetermined concentration.

For example, tau-fluvalinate, and Guadipyr can be applied simultaneously, that is jointly or separately, or in succession, the sequence, in the case of separate application, generally not having any effect on the result of the control measures. In one example, tau-fluvalinate, and Guadipyr prepared separately, and the individual formulations are applied as is, or diluted to predetermined concentrations. In a further example, tau-fluvalinate, and Guadipyr are prepared separately, and the formulations are mixed when diluted to a predetermined concentration. In another example, tau-fluvalinate and Guadipyr are formulated together, and the formulation is applied as it is, or the formulation is diluted to a predetermined concentration.

For example, tau-fluvalinate, and Imidaclothiz can be applied simultaneously, that is jointly or separately, or in succession, the sequence, in the case of separate application, generally not having any effect on the result of the control measures. In one example, tau-fluvalinate, and Imidaclothiz prepared separately, and the individual formulations are applied as is, or diluted to predetermined concentrations. In a further example, tau-fluvalinate, and Imidaclothiz are prepared separately, and the formulations are mixed when diluted to a predetermined concentration. In another example, tau-fluvalinate and Imidaclothiz are formulated together, and the formulation is applied as it is, or the formulation is diluted to a predetermined concentration.

For example, tau-fluvalinate, and Cyflumetofen can be applied simultaneously, that is jointly or separately, or in succession, the sequence, in the case of separate application, generally not having any effect on the result of the control measures. In one example, tau-fluvalinate, and Cyflumetofen prepared separately, and the individual formulations are applied as is, or diluted to predetermined concentrations. In a further example, tau-fluvalinate, and Cyflumetofen are prepared separately, and the formulations are mixed when diluted to a predetermined concentration. In another example, tau-fluvalinate and Cyflumetofen are formulated together, and the formulation is applied as it is, or the formulation is diluted to a predetermined concentration.

For example, tau-fluvalinate, and Sila-Cyflumetofen can be applied simultaneously, that is jointly or separately, or in succession, the sequence, in the case of separate application, generally not having any effect on the result of the control measures. In one example, tau-fluvalinate, and Sila-Cyflumetofen prepared separately, and the individual formulations are applied as is, or diluted to predetermined concentrations. In a further example, tau-fluvalinate, and Sila-Cyflumetofen are prepared separately, and the formulations are mixed when diluted to a predetermined concentration. In another example, tau-fluvalinate and Sila-Cyflumetofen are formulated together, and the formulation is applied as it is, or the formulation is diluted to a predetermined concentration.

For example, tau-fluvalinate, and Cyproflanilide can be applied simultaneously, that is jointly or separately, or in succession, the sequence, in the case of separate application, generally not having any effect on the result of the control measures. In one example, tau-fluvalinate, and Cyproflanilide prepared separately, and the individual formulations are applied as is, or diluted to predetermined concentrations. In a further example, tau-fluvalinate, and Cyproflanilide are prepared separately, and the formulations are mixed when diluted to a predetermined concentration. In another example, tau-fluvalinate and Cyproflanilide are formulated together, and the formulation is applied as it is, or the formulation is diluted to a predetermined concentration. For example, tau-fluvalinate, and Dicloromezotiaz can be applied simultaneously, that is jointly or separately, or in succession, the sequence, in the case of separate application, generally not having any effect on the result of the control measures. In one example, tau-fluvalinate, and Dicloromezotiaz prepared separately, and the individual formulations are applied as is, or diluted to predetermined concentrations. In a further example, tau-fluvalinate, and Dicloromezotiaz are prepared separately, and the formulations are mixed when diluted to a predetermined concentration. In another example, tau-fluvalinate and Dicloromezotiaz are formulated together, and the formulation is applied as it is, or the formulation is diluted to a predetermined concentration.

For example, tau-fluvalinate, and Fenmezoditiaz can be applied simultaneously, that is jointly or separately, or in succession, the sequence, in the case of separate application, generally not having any effect on the result of the control measures. In one example, tau-fluvalinate, and Fenmezoditiaz prepared separately, and the individual formulations are applied as is, or diluted to predetermined concentrations. In a further example, tau-fluvalinate, and Fenmezoditiaz are prepared separately, and the formulations are mixed when diluted to a predetermined concentration. In another example, tau-fluvalinate and Fenmezoditiaz are formulated together, and the formulation is applied as it is, or the formulation is diluted to a predetermined concentration.

For example, tau-fluvalinate, and Dimpropyridaz can be applied simultaneously, that is jointly or separately, or in succession, the sequence, in the case of separate application, generally not having any effect on the result of the control measures. In one example, tau-fluvalinate, and Dimpropyridaz prepared separately, and the individual formulations are applied as is, or diluted to predetermined concentrations. In a further example, tau-fluvalinate, and Dimpropyridaz are prepared separately, and the formulations are mixed when diluted to a predetermined concentration. In another example, tau-fluvalinate and Dimpropyridaz are formulated together, and the formulation is applied as it is, or the formulation is diluted to a predetermined concentration.

For example, tau-fluvalinate, and Tyclopyrazoflor can be applied simultaneously, that is jointly or separately, or in succession, the sequence, in the case of separate application, generally not having any effect on the result of the control measures. In one example, tau-fluvalinate, and Tyclopyrazoflor prepared separately, and the individual formulations are applied as is, or diluted to predetermined concentrations. In a further example, tau-fluvalinate, and Tyclopyrazoflor are prepared separately, and the formulations are mixed when diluted to a predetermined concentration. In another example, tau-fluvalinate and Tyclopyrazoflor are formulated together, and the formulation is applied as it is, or the formulation is diluted to a predetermined concentration.

For example, tau-fluvalinate, and Fluchlordiniliprole can be applied simultaneously, that is jointly or separately, or in succession, the sequence, in the case of separate application, generally not having any effect on the result of the control measures. In one example, tau-fluvalinate, and Fluchlordiniliprole prepared separately, and the individual formulations are applied as is, or diluted to predetermined concentrations. In a further example, tau-fluvalinate, and Fluchlordiniliprole are prepared separately, and the formulations are mixed when diluted to a predetermined concentration. In another example, tau-fluvalinate and Fluchlordiniliprole are formulated together, and the formulation is applied as it is, or the formulation is diluted to a predetermined concentration.

For example, tau-fluvalinate, and Fluazaindolizine can be applied simultaneously, that is jointly or separately, or in succession, the sequence, in the case of separate application, generally not having any effect on the result of the control measures. In one example, tau-fluvalinate, and Fluazaindolizine prepared separately, and the individual formulations are applied as is, or diluted to predetermined concentrations. In a further example, tau-fluvalinate, and Fluazaindolizine are prepared separately, and the formulations are mixed when diluted to a predetermined concentration. In another example, tau-fluvalinate and Fluazaindolizine are formulated together, and the formulation is applied as it is, or the formulation is diluted to a predetermined concentration.

For example, tau-fluvalinate, and Flufiprole can be applied simultaneously, that is jointly or separately, or in succession, the sequence, in the case of separate application, generally not having any effect on the result of the control measures. In one example, tau-fluvalinate, and Flufiprole prepared separately, and the individual formulations are applied as is, or diluted to predetermined concentrations. In a further example, tau-fluvalinate, and Flufiprole are prepared separately, and the formulations are mixed when diluted to a predetermined concentration. In another example, tau-fluvalinate and Flufiprole are formulated together, and the formulation is applied as it is, or the formulation is diluted to a predetermined concentration.

For example, tau-fluvalinate, and Nicofluprole can be applied simultaneously, that is jointly or separately, or in succession, the sequence, in the case of separate application, generally not having any effect on the result of the control measures. In one example, tau-fluvalinate, and Nicofluprole prepared separately, and the individual formulations are applied as is, or diluted to predetermined concentrations. In a further example, tau-fluvalinate, and Nicofluprole are prepared separately, and the formulations are mixed when diluted to a predetermined concentration. In another example, tau-fluvalinate and Nicofluprole are formulated together, and the formulation is applied as it is, or the formulation is diluted to a predetermined concentration.

For example, tau-fluvalinate, and Pyriprole can be applied simultaneously, that is jointly or separately, or in succession, the sequence, in the case of separate application, generally not having any effect on the result of the control measures. In one example, tau-fluvalinate, and Pyriprole prepared separately, and the individual formulations are applied as is, or diluted to predetermined concentrations. In a further example, tau-fluvalinate, and Pyriprole are prepared separately, and the formulations are mixed when diluted to a predetermined concentration. In another example, tau-fluvalinate and Pyriprole are formulated together, and the formulation is applied as it is, or the formulation is diluted to a predetermined concentration.

For example, tau-fluvalinate, and Fluhexafon can be applied simultaneously, that is jointly or separately, or in succession, the sequence, in the case of separate application, generally not having any effect on the result of the control measures. In one example, tau-fluvalinate, and Fluhexafon prepared separately, and the individual formulations are applied as is, or diluted to predetermined concentrations. In a further example, tau-fluvalinate, and Fluhexafon are prepared separately, and the formulations are mixed when diluted to a predetermined concentration. In another example, tau-fluvalinate and Fluhexafon are formulated together, and the formulation is applied as it is, or the formulation is diluted to a predetermined concentration.

For example, tau-fluvalinate, and Bistrifluron can be applied simultaneously, that is jointly or separately, or in succession, the sequence, in the case of separate application, generally not having any effect on the result of the control measures. In one example, tau-fluvalinate, and Bistrifluron prepared separately, and the individual formulations are applied as is, or diluted to predetermined concentrations. In a further example, tau-fluvalinate, and Bistrifluron are prepared separately, and the formulations are mixed when diluted to a predetermined concentration. In another example, tau-fluvalinate and Bistrifluron are formulated together, and the formulation is applied as it is, or the formulation is diluted to a predetermined concentration.

For example, tau-fluvalinate, and Trifluenfuronate can be applied simultaneously, that is jointly or separately, or in succession, the sequence, in the case of separate application, generally not having any effect on the result of the control measures. In one example, tau-fluvalinate, and Trifluenfuronate prepared separately, and the individual formulations are applied as is, or diluted to predetermined concentrations. In a further example, tau-fluvalinate, and Trifluenfuronate are prepared separately, and the formulations are mixed when diluted to a predetermined concentration. In another example, tau-fluvalinate and Trifluenfuronate are formulated together, and the formulation is applied as it is, or the formulation is diluted to a predetermined concentration.

For example, tau-fluvalinate, and Lotilaner can be applied simultaneously, that is jointly or separately, or in succession, the sequence, in the case of separate application, generally not having any effect on the result of the control measures. In one example, tau-fluvalinate, and Lotilaner prepared separately, and the individual formulations are applied as is, or diluted to predetermined concentrations. In a further example, tau-fluvalinate, and Lotilaner are prepared separately, and the formulations are mixed when diluted to a predetermined concentration. In another example, tau-fluvalinate and Lotilaner are formulated together, and the formulation is applied as it is, or the formulation is diluted to a predetermined concentration.

For example, tau-fluvalinate, and Indazapyroxamet can be applied simultaneously, that is jointly or separately, or in succession, the sequence, in the case of separate application, generally not having any effect on the result of the control measures. In one example, tau-fluvalinate, and Indazapyroxamet prepared separately, and the individual formulations are applied as is, or diluted to predetermined concentrations. In a further example, tau-fluvalinate, and Indazapyroxamet are prepared separately, and the formulations are mixed when diluted to a predetermined concentration. In another example, tau-fluvalinate and Indazapyroxamet are formulated together, and the formulation is applied as it is, or the formulation is diluted to a predetermined concentration.

For example, tau-fluvalinate, and one or more Mineral oil can be applied simultaneously, that is jointly or separately, or in succession, the sequence, in the case of separate application, generally not having any effect on the result of the control measures. In one example, tau-fluvalinate, and one or more Mineral oil prepared separately, and the individual formulations are applied as is, or diluted to predetermined concentrations. In a further example, tau-fluvalinate, and one or more Mineral oil are prepared separately, and the formulations are mixed when diluted to a predetermined concentration. In another example, tau-fluvalinate and one or more Mineral oil are formulated together, and the formulation is applied as it is, or the formulation is diluted to a predetermined concentration.

For example, tau-fluvalinate, and paraffinic oils can be applied simultaneously, that is jointly or separately, or in succession, the sequence, in the case of separate application, generally not having any effect on the result of the control measures. In one example, tau-fluvalinate, and paraffinic oils prepared separately, and the individual formulations are applied as is, or diluted to predetermined concentrations. In a further example, tau-fluvalinate, and paraffinic oils are prepared separately, and the formulations are mixed when diluted to a predetermined concentration. In another example, tau-fluvalinate and paraffinic oils are formulated together, and the formulation is applied as it is, or the formulation is diluted to a predetermined concentration.

For example, tau-fluvalinate, and Garlic extract can be applied simultaneously, that is jointly or separately, or in succession, the sequence, in the case of separate application, generally not having any effect on the result of the control measures. In one example, tau-fluvalinate, and Garlic extract prepared separately, and the individual formulations are applied as is, or diluted to predetermined concentrations. In a further example, tau-fluvalinate, and Garlic extract are prepared separately, and the formulations are mixed when diluted to a predetermined concentration. In another example, tau-fluvalinate and Garlic extract are formulated together, and the formulation is applied as it is, or the formulation is diluted to a predetermined concentration.

For example, tau-fluvalinate, and Neem extract can be applied simultaneously, that is jointly or separately, or in succession, the sequence, in the case of separate application, generally not having any effect on the result of the control measures. In one example, tau-fluvalinate, and Neem extract prepared separately, and the individual formulations are applied as is, or diluted to predetermined concentrations. In a further example, tau-fluvalinate, and Neem extract are prepared separately, and the formulations are mixed when diluted to a predetermined concentration. In another example, tau-fluvalinate and Neem extract are formulated together, and the formulation is applied as it is, or the formulation is diluted to a predetermined concentration.

For example, tau-fluvalinate, and Tea tree oil can be applied simultaneously, that is jointly or separately, or in succession, the sequence, in the case of separate application, generally not having any effect on the result of the control measures. In one example, tau-fluvalinate, and Tea tree oil prepared separately, and the individual formulations are applied as is, or diluted to predetermined concentrations. In a further example, tau-fluvalinate, and Tea tree oil are prepared separately, and the formulations are mixed when diluted to a predetermined concentration. In another example, tau-fluvalinate and Tea tree oil are formulated together, and the formulation is applied as it is, or the formulation is diluted to a predetermined concentration.

For example, tau-fluvalinate, and Clove oil can be applied simultaneously, that is jointly or separately, or in succession, the sequence, in the case of separate application, generally not having any effect on the result of the control measures. In one example, tau-fluvalinate, and Clove oil prepared separately, and the individual formulations are applied as is, or diluted to predetermined concentrations. In a further example, tau-fluvalinate, and Clove oil are prepared separately, and the formulations are mixed when diluted to a predetermined concentration. In another example, tau-fluvalinate and Clove oil are formulated together, and the formulation is applied as it is, or the formulation is diluted to a predetermined concentration.

For example, tau-fluvalinate, and Citronella oil can be applied simultaneously, that is jointly or separately, or in succession, the sequence, in the case of separate application, generally not having any effect on the result of the control measures. In one example, tau-fluvalinate, and Citronella oil prepared separately, and the individual formulations are applied as is, or diluted to predetermined concentrations. In a further example, tau-fluvalinate, and Citronella oil are prepared separately, and the formulations are mixed when diluted to a predetermined concentration. In another example, tau-fluvalinate and Citronella oil are formulated together, and the formulation is applied as it is, or the formulation is diluted to a predetermined concentration.

For example, tau-fluvalinate, and Rose oil can be applied simultaneously, that is jointly or separately, or in succession, the sequence, in the case of separate application, generally not having any effect on the result of the control measures. In one example, tau-fluvalinate, and Rose oil prepared separately, and the individual formulations are applied as is, or diluted to predetermined concentrations. In a further example, tau-fluvalinate, and Rose oil are prepared separately, and the formulations are mixed when diluted to a predetermined concentration. In another example, tau-fluvalinate and Rose oil are formulated together, and the formulation is applied as it is, or the formulation is diluted to a predetermined concentration.

For example, tau-fluvalinate, and Palmarosa oil can be applied simultaneously, that is jointly or separately, or in succession, the sequence, in the case of separate application, generally not having any effect on the result of the control measures. In one example, tau-fluvalinate, and Palmarosa oil prepared separately, and the individual formulations are applied as is, or diluted to predetermined concentrations. In a further example, tau-fluvalinate, and Palmarosa oil are prepared separately, and the formulations are mixed when diluted to a predetermined concentration. In another example, tau-fluvalinate and Palmarosa oil are formulated together, and the formulation is applied as it is, or the formulation is diluted to a predetermined concentration.

For example, tau-fluvalinate, and Geraniol can be applied simultaneously, that is jointly or separately, or in succession, the sequence, in the case of separate application, generally not having any effect on the result of the control measures. In one example, tau-fluvalinate, and Geraniol prepared separately, and the individual formulations are applied as is, or diluted to predetermined concentrations. In a further example, tau-fluvalinate, and Geraniol are prepared separately, and the formulations are mixed when diluted to a predetermined concentration. In another example, tau-fluvalinate and Geraniol are formulated together, and the formulation is applied as it is, or the formulation is diluted to a predetermined concentration.

For example, tau-fluvalinate, and Thymol can be applied simultaneously, that is jointly or separately, or in succession, the sequence, in the case of separate application, generally not having any effect on the result of the control measures. In one example, tau-fluvalinate, and Thymol prepared separately, and the individual formulations are applied as is, or diluted to predetermined concentrations. In a further example, tau-fluvalinate, and Thymol are prepared separately, and the formulations are mixed when diluted to a predetermined concentration. In another example, tau-fluvalinate and Thymol are formulated together, and the formulation is applied as it is, or the formulation is diluted to a predetermined concentration.

For example, tau-fluvalinate, and Citronella can be applied simultaneously, that is jointly or separately, or in succession, the sequence, in the case of separate application, generally not having any effect on the result of the control measures. In one example, tau-fluvalinate, and Citronella prepared separately, and the individual formulations are applied as is, or diluted to predetermined concentrations. In a further example, tau-fluvalinate, and Citronella are prepared separately, and the formulations are mixed when diluted to a predetermined concentration. In another example, tau-fluvalinate and Citronella are formulated together, and the formulation is applied as it is, or the formulation is diluted to a predetermined concentration.

For example, tau-fluvalinate, and one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids, can be applied simultaneously, that is jointly or separately, or in succession, the sequence, in the case of separate application, generally not having any effect on the result of the control measures. In one example, tau-fluvalinate, and one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids, prepared separately, and the individual formulations are applied as is, or diluted to predetermined concentrations. In a further example, tau-fluvalinate, and one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids, are prepared separately, and the formulations are mixed when diluted to a predetermined concentration. In another example, tau-fluvalinate and one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids, are formulated together, and the formulation is applied as it is, or the formulation is diluted to a predetermined concentration.

In some embodiments, an amount of tau-fluvalinate and an amount of a synthetic pyrethroid if applied together are more effective than when tau-fluvalinate, at the same amount, and the synthetic pyrethroid at the same amount, is applied alone.

In some embodiments, (i) the amount of tau-fluvalinate and (ii) an amount of a synthetic pyrethroid in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Nicotinic acetylcholine receptor (nAChR) competitive modulator if applied together are more effective than when tau-fluvalinate, at the same amount, and the Nicotinic acetylcholine receptor (nAChR) competitive modulator at the same amount, is applied alone.

In some embodiments, (i) the amount of tau-fluvalinate and (ii) an amount of a Nicotinic acetylcholine receptor (nAChR) competitive modulator in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Uncoupler of oxidative phosphorylation via disruption of proton gradient if applied together are more effective than when tau-fluvalinate, at the same amount, and the Uncoupler of oxidative phosphorylation via disruption of proton gradient at the same amount, is applied alone.

In some embodiments, (i) the amount of tau-fluvalinate and (ii) an amount of a Uncoupler of oxidative phosphorylation via disruption of proton gradient in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Ryanodine receptor modulator if applied together are more effective than when tau-fluvalinate, at the same amount, and the Ryanodine receptor modulator at the same amount, is applied alone.

In some embodiments, (i) the amount of tau-fluvalinate and (ii) an amount of a Ryanodine receptor modulator in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Nicotinic acetylcholine receptor channel blocker if applied together are more effective than when tau-fluvalinate, at the same amount, and the Nicotinic acetylcholine receptor channel blocker at the same amount, is applied alone.

In some embodiments, (i) the amount of tau-fluvalinate and (ii) an amount of a Nicotinic acetylcholine receptor channel blocker in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Mitochondrial complex electron transport inhibitor (METI) if applied together are more effective than when tau-fluvalinate, at the same amount, and the Mitochondrial complex electron transport inhibitor (METI) at the same amount, is applied alone.

In some embodiments, (i) the amount of tau-fluvalinate and (ii) an amount of a Mitochondrial complex electron transport inhibitor (METI) in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a meta-diamide insecticide if applied together are more effective than when tau-fluvalinate, at the same amount, and the meta-diamide insecticide at the same amount, is applied alone.

In some embodiments, (i) the amount of tau-fluvalinate and (ii) an amount of a meta-diamide insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a broad-spectrum insect growth regulator if applied together are more effective than when tau-fluvalinate, at the same amount, and the broad-spectrum insect growth regulator at the same amount, is applied alone.

In some embodiments, (i) the amount of tau-fluvalinate and (ii) an amount of a broad-spectrum insect growth regulator in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Glutamate-gated chloride channel (GluCl) allosteric modulator if applied together are more effective than when tau-fluvalinate, at the same amount, and the Glutamate-gated chloride channel (GluCl) allosteric modulator at the same amount, is applied alone.

In some embodiments, (i) the amount of tau-fluvalinate and (ii) an amount of a Glutamate-gated chloride channel (GluCl) allosteric modulator in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Voltage-dependent sodium channel Blocker if applied together are more effective than when tau-fluvalinate, at the same amount, and the Voltage-dependent sodium channel Blocker at the same amount, is applied alone.

In some embodiments, (i) the amount of tau-fluvalinate and (ii) an amount of a Voltage-dependent sodium channel Blocker in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Inhibitor of chitin biosynthesis affecting CHS1 if applied together are more effective than when tau-fluvalinate, at the same amount, and the Inhibitor of chitin biosynthesis affecting CHS1 at the same amount, is applied alone.

In some embodiments, (i) the amount of tau-fluvalinate and (ii) an amount of a Inhibitor of chitin biosynthesis affecting CHS1 in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Inhibitor of acetyl CoA carboxylase if applied together are more effective than when tau-fluvalinate, at the same amount, and the Inhibitor of acetyl COA carboxylase at the same amount, is applied alone.

In some embodiments, (i) the amount of tau-fluvalinate and (ii) an amount of an Inhibitor of acetyl CoA carboxylase in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Entomopathogenic fungal agent if applied together are more effective than when tau-fluvalinate, at the same amount, and the Entomopathogenic fungal agent at the same amount, is applied alone. In some embodiments, (i) the amount of tau-fluvalinate and (ii) an amount of an Entomopathogenic fungal agent in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Granuloviruses if applied together are more effective than when tau-fluvalinate, at the same amount, and the Granuloviruses at the same amount, is applied alone.

In some embodiments, (i) the amount of tau-fluvalinate and (ii) an amount of a Granuloviruses in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Nucleoopolyhedrosisvirus if applied together are more effective than when tau-fluvalinate, at the same amount, and the Nucleoopolyhedrosisvirus at the same amount, is applied alone.

In some embodiments, (i) the amount of tau-fluvalinate and (ii) an amount of a Nucleoopolyhedrosisvirus in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Mitochondrial complex III electron transport inhibitor-Qi site if applied together are more effective than when tau-fluvalinate, at the same amount, and the Mitochondrial complex III electron transport inhibitor—Qi site at the same amount, is applied alone.

In some embodiments, (i) the amount of tau-fluvalinate and (ii) an amount of a Mitochondrial complex III electron transport inhibitor-Qi site in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Chitin biosynthesis inhibitor (type 1) if applied together are more effective than when tau-fluvalinate, at the same amount, and the Chitin biosynthesis inhibitor (type 1) at the same amount, is applied alone.

In some embodiments, (i) the amount of tau-fluvalinate and (ii) an amount of a Chitin biosynthesis inhibitor (type 1) in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Ecdysone receptor agonist if applied together are more effective than when tau-fluvalinate, at the same amount, and the Ecdysone receptor agonist at the same amount, is applied alone.

In some embodiments, (i) the amount of tau-fluvalinate and (ii) an amount of an Ecdysone receptor agonist in a ratio from 1:100 to 100:1, if applied together are more effective in treating a plant or soil against insect infection than if (i) at the same amount, and (ii) at the same amount, is applied alone.

In some embodiments, (i) the amount of tau-fluvalinate and (ii) an amount of an Ecdysone receptor agonist in a ratio from 1:50 to 50:1, if applied together are more effective in treating a plant or soil against insect infection than if (i) at the same amount, and (ii) at the same amount, is applied alone.

In some specific embodiments, (i) the amount of tau-fluvalinate and (ii) an amount of Methoxyfenozide in a ratio from 1:50 to 50:1, if applied together are more effective in treating a plant or soil against insect infection than if (i) at the same amount, and (ii) at the same amount, is applied alone.

In a more specific embodiment, (i) the amount of tau-fluvalinate and (ii) an amount of Methoxyfenozide in a ratio from 1:1 to 5:1, if applied together are more effective in treating a plant or soil against insect infection than if (i) at the same amount, and (ii) at the same amount, is applied alone.

In some embodiments, an amount of tau-fluvalinate and an amount of an Mitochondrial complex III electron transport inhibitor (Qo site) if applied together are more effective than when tau-fluvalinate, at the same amount, and the Mitochondrial complex III electron transport inhibitor (Qo site) at the same amount, is applied alone.

In some embodiments, (i) the amount of tau-fluvalinate and (ii) an amount of an Mitochondrial complex III electron transport inhibitor (Qo site) in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Cyclotide insecticide and repellent if applied together are more effective than when tau-fluvalinate, at the same amount, and the Cyclotide insecticide and repellent at the same amount, is applied alone.

In some embodiments, (i) the amount of tau-fluvalinate and (ii) an amount of a Cyclotide insecticide and repellent in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Nicotinic acetylcholine receptor (nAChR) allosteric modulator (site II) if applied together are more effective than when tau-fluvalinate, at the same amount, and the Nicotinic acetylcholine receptor (nAChR) allosteric modulator (site II) at the same amount, is applied alone.

In some embodiments, (i) the amount of tau-fluvalinate and (ii) an amount of a Nicotinic acetylcholine receptor (nAChR) allosteric modulator (site II) in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Calcium-activated potassium channel (KCa2) modulator if applied together are more effective than when tau-fluvalinate, at the same amount, and the Calcium-activated potassium channel (KCa2) modulator at the same amount, is applied alone.

In some embodiments, (i) the amount of tau-fluvalinate and (ii) an amount of a Calcium-activated potassium channel (KCa2) modulator in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Insecticide synergist if applied together are more effective than when tau-fluvalinate, at the same amount, and the Insecticide synergist at the same amount, is applied alone.

In some embodiments, (i) the amount of tau-fluvalinate and (ii) an amount of an Insecticide synergist in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Fungicide if applied together are more effective than when tau-fluvalinate, at the same amount, and the Fungicide at the same amount, is applied alone.

In some embodiments, (i) the amount of tau-fluvalinate and (ii) an amount of a Fungicide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Neonicotinoid insecticide if applied together are more effective than when tau-fluvalinate, at the same amount, and the Neonicotinoid insecticide at the same amount, is applied alone.

In some embodiments, (i) the amount of tau-fluvalinate and (ii) an amount of a Neonicotinoid insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Acaricide if applied together are more effective than when tau-fluvalinate, at the same amount, and the Acaricide at the same amount, is applied alone.

In some embodiments, (i) the amount of tau-fluvalinate and (ii) an amount of an Acaricide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Diamide insecticide if applied together are more effective than when tau-fluvalinate, at the same amount, and the Diamide insecticide at the same amount, is applied alone.

In some embodiments, (i) the amount of tau-fluvalinate and (ii) an amount of a Diamide insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Mesoionic insecticide if applied together are more effective than when tau-fluvalinate, at the same amount, and the Mesoionic insecticide at the same amount, is applied alone.

In some embodiments, (i) the amount of tau-fluvalinate and (ii) an amount of a Mesoionic insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Pyrazole carboxamide insecticide if applied together are more effective than when tau-fluvalinate, at the same amount, and the Pyrazole carboxamide insecticide at the same amount, is applied alone.

In some embodiments, (i) the amount of tau-fluvalinate and (ii) an amount of a Pyrazole carboxamide insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Sulfonamide nematicide if applied together are more effective than when tau-fluvalinate, at the same amount, and the Sulfonamide nematicide at the same amount, is applied alone.

In some embodiments, (i) the amount of tau-fluvalinate and (ii) an amount of a Sulfonamide nematicide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Phenylpyrazole insecticide if applied together are more effective than when tau-fluvalinate, at the same amount, and the Phenylpyrazole insecticide at the same amount, is applied alone.

In some embodiments, (i) the amount of tau-fluvalinate and (ii) an amount of a Phenylpyrazole insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a Fluorine containing insecticide if applied together are more effective than when tau-fluvalinate, at the same amount, and the Fluorine containing insecticide at the same amount, is applied alone.

In some embodiments, (i) the amount of tau-fluvalinate and (ii) an amount of a Fluorine containing insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Isoxazoline parasiticide if applied together are more effective than when tau-fluvalinate, at the same amount, and the Isoxazoline parasiticide at the same amount, is applied alone.

In some embodiments, (i) the amount of tau-fluvalinate and (ii) an amount of an Isoxazoline parasiticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of an Indazole insecticide if applied together are more effective than when tau-fluvalinate, at the same amount, and the Indazole insecticide at the same amount, is applied alone.

In some embodiments, (i) the amount of tau-fluvalinate and (ii) an amount of an Indazole insecticide in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of one or more Mineral oil if applied together are more effective than when tau-fluvalinate, at the same amount, and one or more Mineral oil at the same amount, is applied alone.

In some embodiments, (i) the amount of tau-fluvalinate and (ii) an amount of one or more Mineral oil in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a plant extract if applied together are more effective than when tau-fluvalinate, at the same amount, and the plant extract at the same amount, is applied alone.

In some embodiments, (i) the amount of tau-fluvalinate and (ii) an amount of a plant extract in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of a repellant if applied together are more effective than when tau-fluvalinate, at the same amount, and the repellant at the same amount, is applied alone.

In some embodiments, (i) the amount of tau-fluvalinate and (ii) an amount of a repellant in a ratio from 1:100 to 100:1, if applied together are more effective in treating a plant or soil against insect infection than if (i) at the same amount, and (ii) at the same amount, is applied alone.

In some embodiments, an amount of tau-fluvalinate and an amount of one or more agrochemically acceptable additives if applied together are more effective than when tau-fluvalinate, at the same amount, and the one or more agrochemically acceptable additives at the same amount, is applied alone.

In some embodiments, (i) the amount of tau-fluvalinate and (ii) an amount of one or more agrochemically acceptable additives in a ratio from 1:100 to 100:1, if applied together are more effective in treating a plant or soil against insect infection than if (i) at the same amount, and (ii) at the same amount, is applied alone.

In a further embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after several hours to several days of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 48 hours of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 72 hours of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 1 day of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 2 days of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 4 days of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 6 days of applications.

In an embodiment, the mixture combination of active compounds of the invention comprising: (i) tau-fluvalinate; and (ii) at least one crop protection chemical compound II as defined above, is synergistically effective for controlling pests compared to when compound (i) at the same amount, and compound (ii) at the same amount, is applied alone, after 7 days of applications.

In yet another embodiment, the synergistic composition may be applied in various mixtures or combinations of Tau-fluvalinate, and a crop protection chemical compound II, as defined above, for example in a single “ready-for-use” form, or in a combined spray mixture composed from separate formulations of the single active ingredients, such as a “tank-mix” form.

In yet another embodiment, the composition is applied in the form of a ready-for-use formulation comprising Tau-fluvalinate, and a crop protection chemical compound. This formulation can be obtained by combining the active ingredients in an effective amount with an agriculturally acceptable carrier, a surfactant or other application-promoting adjuvant customarily employed in formulation technology.

According to an embodiment, the composition comprises at least one additional component selected from the group of surfactants, solid diluents and liquid diluents. Such compositions can be formulated using agriculturally acceptable carriers, surfactants or other application-promoting adjuvants customarily employed in formulation technology and formulation techniques that are known in the art.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, a solvent or oil, which are suitable for dilution with water.

In an embodiment, the amount of the mixture of active ingredients in the composition is about 0.1-99 wt. %, about 0.1-95 wt. %, or about 0.1-90 wt. %, based on the total weight of the composition. In another embodiment, the amount of the mixture of active ingredients in the composition is about 1-70 wt. %, based on the total weight of the composition. In yet another embodiment, the amount of the mixture of active ingredients in the composition is about 1-50 wt. %, based on the total weight of the composition. In yet another embodiment, the amount of the mixture of active ingredients in the composition is about 1-40 wt. %, based on the total weight of the composition. In yet another embodiment, the amount of the mixture of active ingredients in the composition is about 1-30 wt. %, based on the total weight of the composition. In yet another embodiment, the amount of the mixture of active ingredients in the composition is about 1-20 wt. %, based on the total weight of the composition. In yet another embodiment, the amount of the mixture of active ingredients in the composition is about 1-10 wt. %, based on the total weight of the composition. The remaining components in the formulation are for example the carrier and additives.

In an embodiment, the amount of the mixture of active ingredients in the composition is from about 0.1%, 0.5%, 1%, 1.5%, 2%, 2.5%, 3%, 3.5%, 4%, 4.5%, 5% to about 90%, 93%, 95%, 98%, 99% based on the total weight of the composition.

In another embodiment, the present invention provides a kit comprising a synergistic pesticidal composition as described herein, or components thereof. Such kits may comprise, in addition to the aforementioned active components, one or more additional active and/or inactive ingredients, either within the provided pesticidal composition or separately.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater pesticidal activity than the sum of the activities of the individual components.

### Method of Use

The present invention provides a method for enhancing root systems and/or enhancing crop plants development and/or enhancing crop plants vigor and/or improving plant potential yield comprising applying an effective amount of the any one of the mixtures or compositions disclosed herein to one or more plants, the locus thereof or propagation material thereof.

The present invention provides a method for enhancing plant development comprising applying an effective amount of the any one of the mixtures or the compositions disclosed herein to one or more plants, the locus thereof or propagation material thereof so as to thereby enhance plant development.

The present invention provides a method for enhancing root system comprising applying an effective amount of the any one of the mixtures or the compositions disclosed herein to one or more plants, the locus thereof or propagation material thereof so as to thereby enhance the root system.

The present invention provides a method for enhancing plant vigor comprising applying an effective amount of the any one of the mixtures or the compositions disclosed herein to one or more plants, the locus thereof or propagation material thereof so as to thereby enhance plant vigor.

The present invention provides a method for improving plant potential yield comprising applying an effective amount of the any one of the mixtures or the compositions disclosed herein to one or more plants, the locus thereof or propagation material thereof so as to thereby improve plant potential yield.

The present invention provides a method for regulating plant growth comprising applying an effective amount of the any one of the mixtures or the compositions disclosed herein to one or more plants, the locus thereof or propagation material thereof so as to thereby regulate plant growth.

The present invention provides a method for control of insects by contacting the insect or their food supply, habitat, breeding grounds or their locus with an effective amount of the any one of the mixtures or the compositions disclosed herein so as to thereby control insects.

The present invention provides a method of protecting plants from attack or infestation by insects comprising contacting the plant, or the soil or water in which the plant is growing, with an effective amount of the any one of the mixtures or the compositions disclosed herein so as to thereby protecting plants from attack or infestation by insects.

This present invention also provides a method for enhancing knock-down activity and/or prolonged control comprising contacting the plant, or the soil or water in which the plant is growing, with an effective amount of the mixture of Tau-fluvalinate and one or more active compounds II, as mentioned above or the composition thereof, so as to thereby enhance knock-down activity and/or prolonged control.

In an embodiment, this invention provides a method for controlling the insect comprising contacting the insect or their food supply, habitat, breeding grounds or their locus with an effective amount of the mixture combination of Tau-fluvalinate and one or more active compounds II, as mentioned above or the composition thereof, thereby controlling the said insect.

In an embodiment, this invention provides a method for controlling the insect comprising contacting the insect or their food supply, habitat, breeding grounds or their locus with an effective amount of the mixture combination of Tau-fluvalinate and one or more active compounds II, as mentioned above or the composition thereof, wherein the insect is selected from a group comprising Spidermites, Halotydeus spp. Tetranychus urticae, Spodoptera littoralis, Spodoptera spp, Helicoverpa spp., Aphis spp., Myzus spp., Bemisia tabaci, Trialurodes vaporariorum, Tuta absoluta, Halyomorpha halys, Drosophila spp., Frankliniella spp., Aphis gossypii, Tetranichus spp., Lygus spp., Bactrocera dorsalis, B. tryoni, Ceratitis spp., Ceratitis capitata, Bactericera cockerelli, Nysius spp, Nilaparvata lugens, Ectomyelois ceratoniae, Amyelosis transitella, C. auricilius, Chilo spp., Cnaphalocerus medinalis, Cydia pomonella, S. innotata, Scirpophaga incertulas, Eriococcus spp, Ulonemia spp, Heliothrips haemorrhaidalis, Selenothrips spp and Chaetanaphothrips spp.

In an embodiment, this invention provides for controlling the insect, Bemisia tabaci by contacting the insect or their food supply, habitat, breeding grounds or their locus with an effective amount of the mixture combination of Tau fluvalinate and the crop protection chemical as defined above, in a weight ratio from 1:100 to 100:1, so as to thereby controlling the said insect.

In another embodiment, this invention provides for controlling the insect, Bemisia tabaci by contacting the insect or their food supply, habitat, breeding grounds or their locus with an effective amount of the mixture of Tau fluvalinate and a Nicotinic acetylcholine receptor (nAChR) competitive modulator, in a weight ratio from 1:100 to 100:1, so as to thereby controlling the said insect.

In a specific embodiment, this invention provides for controlling the insect, Bemisia tabaci by contacting the insect or their food supply, habitat, breeding grounds or their locus with an effective amount of the mixture of Tau fluvalinate and Flupyrimin, in a weight ratio from 1:100 to 100:1, so as to thereby controlling the said insect.

In an embodiment, this invention provides for controlling the insect, Bemisia tabaci by contacting the insect or their food supply, habitat, breeding grounds or their locus with an effective amount of the mixture of Tau fluvalinate and a meta-diamide insecticide, in a weight ratio from 1:100 to 100:1, so as to thereby controlling the said insect.

In a specific embodiment, this invention provides for controlling the insect, Bemisia tabaci by contacting the insect or their food supply, habitat, breeding grounds or their locus with an effective amount of the mixture of Tau fluvalinate and Isocycloseram, in a weight ratio from 1:100 to 100:1, so as to thereby controlling the said insect.

In an embodiment, this invention provides for controlling the insect, Bemisia tabaci by contacting the insect or their food supply, habitat, breeding grounds or their locus with an effective amount of the mixture of Tau fluvalinate and a plant extract, in a weight ratio from 1:100 to 100:1, so as to thereby controlling the said insect.

In a specific embodiment, this invention provides for controlling the insect, Bemisia tabaci by contacting the insect or their food supply, habitat, breeding grounds or their locus with an effective amount of the mixture of Tau fluvalinate and Garlic extract, in a weight ratio from 1:100 to 100:1, so as to thereby controlling the said insect.

In an embodiment, this invention provides for controlling the insect, Spodoptera littoralis by contacting the insect or their food supply, habitat, breeding grounds or their locus with an effective amount of the mixture combination of Tau fluvalinate and the crop protection chemical as defined above, in a weight ratio from 1:100 to 100:1, so as to thereby controlling the said insect.

In an embodiment, this invention provides for controlling the insect, Spodoptera littoralis by contacting the insect or their food supply, habitat, breeding grounds or their locus with an effective amount of the mixture of Tau fluvalinate and a Nicotinic acetylcholine receptor (nAChR) competitive modulator, in a weight ratio from 1:100 to 100:1, so as to thereby controlling the said insect.

In a specific embodiment, this invention provides for controlling the insect, Spodoptera littoralis by contacting the insect or their food supply, habitat, breeding grounds or their locus with an effective amount of the mixture of Tau fluvalinate and Flupyrimin, in a weight ratio from 1:100 to 100:1, so as to thereby controlling the said insect.

In an embodiment, this invention provides for controlling the insect, Spodoptera littoralis by contacting the insect or their food supply, habitat, breeding grounds or their locus with an effective amount of the mixture of Tau fluvalinate and an Ecdysone receptor agonist, in a weight ratio from 1:100 to 100:1, so as to thereby controlling the said insect.

In a specific embodiment, this invention provides for controlling the insect, Spodoptera littoralis by contacting the insect or their food supply, habitat, breeding grounds or their locus with an effective amount of the mixture of Tau fluvalinate and Methoxyfenozide, in a weight ratio from 1:100 to 100:1, so as to thereby controlling the said insect.

In an embodiment, this invention provides for controlling the insect, Spodoptera littoralis by contacting the insect or their food supply, habitat, breeding grounds or their locus with an effective amount of the mixture of Tau fluvalinate and a meta-diamide insecticide, in a weight ratio from 1:100 to 100:1, so as to thereby controlling the said insect.

In a specific embodiment, this invention provides for controlling the insect, Spodoptera littoralis by contacting the insect or their food supply, habitat, breeding grounds or their locus with an effective amount of the mixture of Tau fluvalinate and Isocycloseram, in a weight ratio from 1:100 to 100:1, so as to thereby controlling the said insect.

The following representative examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and coverage of the invention.

In some embodiments, the mixture or synergistic mixture comprises one or more additional active ingredient. In some embodiments, the mixture or synergistic mixture comprises one or more additional non-active ingredients.

While the present disclosure of the invention may be susceptible to various modifications and alternative forms, specific embodiments have been described by way of example in detail herein. However, it is understood that the present disclosure is not intended to be limited to the particular forms disclosed. Rather, the present disclosure is to cover all modifications, equivalents, and alternatives falling within the scope of the present disclosure as defined by the following claims and their legal equivalents.

### Representative Examples

Experiments may be carried out to determine the synergistic effect of the mixture combination which comprises a mixture of i) Tau-fluvalinate and ii) a crop protection chemical compound such as Flupyrimin, Isocycloseram, Methoxyfenozide, Garlic extract, Gamma-cyhalothrin, Alpha-cypermethrin, Flupyradifurone, Chlorfenapyr, Tetrachlorantraniliprole, Bensultap, Fenazaquin, Fluxametamide, Fenoxycarb, Milbemectin, Metaflumizone, Diflubenzuron, Spidoxamat, Granuloviruses, Nucleoopolyhedrosisvirus, Flometoquin, Buprofezin, Chromafenozide, Acequinocyl, Clotoria Ternatea, GS-omega/kappa HXTX-Hv1a peptide, Acynonapyr, N-octyl bicycloheptene dicarboximide (MGK-264), Pydiflumetofen, Cycloxaprid, Cyflumetofen, Cyproflanilide, Dicloromezotiaz, Dimpropyridaz, Fluazaindolizine, Flufiprole, Fluhexafon, Lotilaner, Indazapyroxamet, paraffinic oils, Thymol, Diatomaceous earth and Polydimethylsiloxane.

A mixture combination were prepared by thoroughly mixing Tau-fluvalinate (weight %) with a crop protection chemical compound such as Flupyrimin, Isocycloseram, Methoxyfenozide and Garlic extract (weight %).

Different concentrations of each of the active ingredients may be applied to different species of insects. The percent controls are determined sometime after treatment.

A synergistic effect exists whenever the action of a combination of active ingredients is greater than the sum of the action of each of the ingredients alone. Therefore, a synergistic combination is a combination of active ingredients having an action that is greater than the sum of the action of each active ingredient alone, and a synergistically effective amount is an effective amount of a synergistic combination.

Colby's method is used to determine if synergy exists for a combination of active ingredients. According to Colby, the expected action (E) of active ingredients A+B is:

E=A+B−(AB/100)
where E=expected efficacy, A and B=the efficacy of two active ingredients A and B at a given dose.

When the percentage of control observed (O) for the combination is greater than the expected (E) percentage, there is a synergistic effect. The synergism ratio (R) is calculated as the ratio between the expected values and observed values. If the synergism ratio (R) between observed and expected is >1 then synergy is exhibited, if R=1 then the effect is additive and if R<1 then the mix is antagonistic.

For a more detailed description of the Colby formula, see Colby, S. R. “Calculating synergistic and antagonistic responses of herbicide combination,” Weeds, Vol. 15, pages 20-22; 1967; see also Limpel et al., Proc. NEWCC 16:48-53 (1962).

The insecticidal compounds A (Tau fluvalinate) and B (mix partner) are formulated as equivalent compositions to eliminate the effects of differing formulation inerts on biological activity. Efficacy of the insecticidal compositions is evaluated with reference to a scale of 0% to 100% in comparison with untreated control plots. 0 means no damage and 100 means complete destruction of the harmful pests.

The experiments were conducted by applying either by synthesis/extraction or commercially available formulations of Tau fluvalinate and other mixture partners, alone or with their tank-mixed compositions with the same weight ratio. The compositions were diluted with water or some other suitable solvents to the stated concentration of the active compounds.

Each formulation with active ingredient is diluted with water or other suitable solvent(s) to the ppm (parts per million) level and biological efficacy trials on pests are conducted.

Following experimentations were done with various mixtures of Tau fluvalinate on different types of pests, the result of which are summarized in the below tables:

TABLE 1
Tau-Fluvalinate + Flupyrimin
A)
Synergistic Activity of a Tau-Fluvalinate + Flupyrimin
against B. tabaci, 3 days after nymph exposition

| | | Observed | Expected | Synergism |
|---|---|---|---|---|
| | Rate | % control | % control | Ratio |
| Active Ingredient | (ppm) | (O) | (E) | (R) |
| Tau- Fluvalinate | 0.1 | 14 | — | |
| Flupyrimin 1.1 EC | 0.1 | 24.4 | — | |
| Tau- Fluvalinate + | 0.1 + 0.1 | 52.9 | 34.98 | 1.512 |
| Flupyrimin 1.1 EC | | | | |

B)
Synergistic Activity of a Tau-Fluvalinate + Flupyrimin
against S. littoralis, 2 days after larvae exposition

| | | Observed | Expected | Synergism |
|---|---|---|---|---|
| | Rate | % control | % control | Ratio |
| Active Ingredient | (ppm) | (O) | (E) | (R) |
| Tau- Fluvalinate | 10 | 43 | — | |
| Flupyrimin | 1 | 0 | — | |
| Flupyrimin | 10 | 0 | — | |
| Flupyrimin | 100 | 18 | — | |
| Tau- Fluvalinate + | 10 + 1 | 90 | 43 | 2.093 |
| Flupyrimin | | | | |
| Tau- Fluvalinate + | 10 + 10 | 75 | 43 | 1.744 |
| Flupyrimin | | | | |
| Tau- Fluvalinate + | 10 + 100 | 90 | 53.26 | 1.690 |
| Flupyrimin | | | | |

TABLE 2
Tau-Fluvalinate + Garlic Extract
Synergistic Activity of a Tau-Fluvalinate + Garlic Extract
against B. tabaci, 3 days after nymph exposition

| | | Observed | Expected | Synergism |
|---|---|---|---|---|
| | Rate | % control | % control | Ratio |
| Active Ingredient | (ppm) | (O) | (E) | (R) |
| Tau- Fluvalinate | 20 | 28.1 | — | |
| Garlic Extract | 20 | 19.8 | — | |
| Garlic Extract | 40 | 33.8 | — | |
| Tau-Fluvalinate + | 20 + 20 | 48.6 | 42.34 | 1.148 |
| Garlic Extract | | | | |
| Tau-Fluvalinate + | 20 + 40 | 54.8 | 52.4 | 1.046 |
| Garlic Extract | | | | |

TABLE 3
Tau-Fluvalinate + Methoxyfenozide
Synergistic Activity of a Tau-Fluvalinate + Methoxyfenozide
against S. littoralis, 3 days after larvae exposition

| | | Observed | Expected | Synergism |
|---|---|---|---|---|
| | Rate | % control | % control | Ratio |
| Active Ingredient | (ppm) | (O) | (E) | (R) |
| Tau- Fluvalinate | 0.2 | 2.5 | — | |
| Tau- Fluvalinate | 2 | 22.5 | — | |
| Tau- Fluvalinate | 10 | 67.5 | — | |
| Methoxyfenozide | 1 | 52.5 | — | |
| Methoxyfenozide | 2 | 70 | — | |
| Tau- Fluvalinate + | 0.2 + 2 | 90 | 70.75 | 1.272 |
| Methoxyfenozide | | | | |
| Tau- Fluvalinate + | 2 + 2 | 82.5 | 76.75 | 1.075 |
| Methoxyfenozide | | | | |
| Tau- Fluvalinate + | 10 + 1 | 85 | 84.56 | 1.005 |
| Methoxyfenozide | | | | |

TABLE 4
Tau-Fluvalinate + Isocycloseram
A)
Synergistic Activity of a Tau-Fluvalinate + Isocycloseram
against B. tabaci, 3 days after nymph exposition

| | | Observed | Expected | Synergism |
|---|---|---|---|---|
| | Rate | % control | % control | Ratio |
| Active Ingredient | (ppm) | (O) | (E) | (R) |
| Tau- Fluvalinate | 0.2 | 10.4 | — | |
| Isocycloseram | 0.2 | 25.5 | — | |
| Tau- Fluvalinate + | 0.2 + 0.2 | 46.3 | 33.25 | 1.392 |
| Isocycloseram | | | | |

B)
Synergistic Activity of a Tau-Fluvalinate + Isocycloseram
against S. littoralis, 2 days after larvae exposition

| | | Observed | Expected | Synergism |
|---|---|---|---|---|
| | Rate | % control | % control | Ratio |
| Active Ingredient | (ppm) | (O) | (E) | (R) |
| Tau- Fluvalinate | 8 | 45 | — | |
| Tau- Fluvalinate | 16 | 62.5 | | |
| Isocycloseram | 8 | 12.2 | — | |
| Tau- Fluvalinate + | 8 + 8 | 85 | 51.71 | 1.644 |
| Isocycloseram | | | | |
| Tau- Fluvalinate + | 16 + 8 | 95 | 70.94 | 1.340 |
| Isocycloseram | | | | |

The green cells represent very high synergistic effect (above 120%), light green cells represent more than 100% but below 120% synergism, i.e. not antagonism but below pronounced synergism.

While the present disclosure of the invention may be susceptible to various modifications and alternative forms, specific embodiments have been described by way of example in detail herein. However, it is understood that the present disclosure is not intended to be limited to the particular forms disclosed. Rather, the present disclosure is to cover all modifications, equivalents, and alternatives falling within the scope of the present disclosure as defined by the following claims and their legal equivalents.

What is claimed is:

1. A mixture combination of active compounds comprising:
i) Tau-fluvalinate and
ii) at least one crop protection chemical compound II selected from a group comprising (1) to (38):
(1) a synthetic pyrethroid selected from a group consisting of Gamma-cyhalothrin, Alpha-cypermethrin, Etofenprox and Tefluthrin,
(2) a Nicotinic acetylcholine receptor (nAChR) competitive modulator selected from a group comprising Flupyradifurone, Flupyrimin, and Triflumezopyrim,
(3) an Uncoupler of oxidative phosphorylation via disruption of proton gradient comprising Chlorfenapyr and Brochlorfenapyr,
(4) a Ryanodine receptor modulator selected from a group comprising Tetrachlorantraniliprole and Thiotraniliprole,
(5) a Nicotinic acetylcholine receptor channel blocker selected from a group comprising Bensultap, Cartap hydrochloride, Thiocyclam and Thisultap-sodium,
(6) a Mitochondrial complex electron transport inhibitor (METI) selected from a group comprising Fenazaquin, Pyridaben, Pyrimidifen, Tebufenpyrad and Cyetpyrafen,
(7) a meta-diamide insecticide selected from a group comprising Fluxametamide and Isocycloseram,
(8) a broad-spectrum insect growth regulator selected from a group comprising Fenoxycarb,
(9) a Glutamate-gated chloride channel (GluCl) allosteric modulator selected from a group comprising Milbemectin and Lepimectin,
(10) a Voltage-dependent sodium channel Blocker selected from a group comprising Metaflumizone,
(11) an Inhibitor of chitin biosynthesis affecting CHS1, selected from a group comprising Diflubenzuron, Flufenoxuron, Lufenuron, Teflubenzuron and Chlorfluazuron,
(12) an Inhibitor of acetyl CoA carboxylase selected from a group comprising Spidoxamat, Spirodiclofen and Spiromesifen,
(13) an Entomopathogenic fungal agent comprising Beauveria spp, Metarhizium spp and Paecilomyces spp,
(14) a Baculovirus comprising:
Granuloviruses such as Cydia pomonella GV, Thaumatotibia leucotreta GV,
Nucleoopolyhedrosisvirus such as Anticarsia gemmatalis MNPV and Helicoverpa armigera NPV,
(15) a Mitochondrial complex III electron transport inhibitors-Qi site comprising Flometoquin,
(16) a Chitin biosynthesis inhibitor (type 1) comprising Buprofezin,
(17) an Ecdysone receptor agonist comprising Chromafenozide, Halofenozide, Methoxyfenozide and Tebufenozide,
(18) a Mitochondrial complex III electron transport inhibitor (Qo site) comprising Acequinocyl, Fluacrypyrim and Hydramethylnon,
(19) a Cyclotide insecticide and repellent comprising Clotoria Ternatea,
(20) a Nicotinic acetylcholine receptor (nAChR) allosteric modulator (site II) comprising GS-omega/kappa HXTX-Hv1a peptide,
(21) a Calcium-activated potassium channel (KCa2) modulator comprising Acynonapyr,
(22) an Insecticide synergist comprising N-octyl bicycloheptene dicarboximide (MGK-264), Piprotal, Propyl isome, Sesamex, Sesamolin and Sulfoxide,
(23) a Fungicide selected from a group comprising Pydiflumetofen, Fluazinam, Fluxapyroxad, Difenoconazole, Tebuconazole, Fludioxonil, Azoxystrobin and Mancozeb,
(24) a Neonicotinoid insecticide selected from a group comprising Cycloxaprid, Guadipyr and Imidaclothiz,
(25) an Acaricide selected from a group comprising Cyflumetofen and Sila-Cyflumetofen,
(26) a Diamide insecticide selected from a group comprising Cyproflanilide,
(27) a Mesoionic insecticide selected from a group comprising Dicloromezotiaz and Fenmezoditiaz,
(28) a Pyrazole carboxamide insecticide selected from a group comprising Dimpropyridaz, Tyclopyrazoflor, Fluchlordiniliprole,
(29) a Sulfonamide nematicide selected from a group comprising Fluazaindolizine,
(30) a Phenylpyrazole insecticide selected from a group comprising Flufiprole, Nicofluprole and Pyriprole,
(31) a Fluorine containing insecticide selected from a group comprising Fluhexafon, Bistrifluron and Trifluenfuronate,
(32) an Isoxazoline parasiticide selected from a group comprising Lotilaner,
(33) an Indazole insecticide selected from a group comprising Indazapyroxamet,
(34) one or more Mineral oil which includes paraffinic oils,
(35) a plant extract selected from a group comprising Garlic extract, Neem extract, Tea tree oil and Clove oil,
(36) a monoterpene alcohol extracted from essential oils selected from a group comprising Citronella oil, Rose oil and Palmarosa oil, wherein monoterpene alcohol is selected from group comprising Geraniol,
(37) a repellant selected from a group comprising Thymol and Citronella; and
(38) one or more agrochemically acceptable additives selected from a group comprising Diatomaceous earth, Amorphous silica, Hydroxylpropyl methylcellulose, Kaolin (calcined), Polydimethylsiloxane and Potassium salts of fatty acids.

2. The mixture combination of claim 1, wherein the weight ratio of Tau fluvalinate and one or more active compounds II as defined in claim 1, is from 1:100 to 100:1.

3. The mixture combination of claim 1, wherein Tau fluvalinate and at least one crop protection chemical compound II as defined in claim 1, are applied jointly or in a succession.

4. The mixture combination of any one of claims 1-3, wherein the mixture is selected from the group comprising:
1) Tau-fluvalinate and Gamma-cyhalothrin,
2) Tau-fluvalinate and Alpha-cypermethrin,
3) Tau-fluvalinate and Etofenprox,
4) Tau-fluvalinate and Tefluthrin,
5) Tau-fluvalinate and Flupyradifurone,
6) Tau-fluvalinate and Flupyrimin,
7) Tau-fluvalinate and Triflumezopyrim,
8) Tau-fluvalinate and Chlorfenapyr,
9) Tau-fluvalinate and Brochlorfenapyr,
10) Tau-fluvalinate and Tetrachlorantraniliprole,
11) Tau-fluvalinate and Thiotraniliprole,
12) Tau-fluvalinate and Bensultap,
13) Tau-fluvalinate and Cartap hydrochloride,
14) Tau-fluvalinate and Thiocyclam,
15) Tau-fluvalinate and Thisultap-sodium,
16) Tau-fluvalinate and Fenazaquin,
17) Tau-fluvalinate and Pyridaben,
18) Tau-fluvalinate and Pyrimidifen,
19) Tau-fluvalinate and Tebufenpyrad,
20) Tau-fluvalinate and Cyetpyrafen
21) Tau-fluvalinate and Fluxametamide
22) Tau-fluvalinate and Isocycloseram
23) Tau-fluvalinate and Fenoxycarb
24) Tau-fluvalinate and Milbemectin
25) Tau-fluvalinate and Lepimectin
26) Tau-fluvalinate and Metaflumizone
27) Tau-fluvalinate and Diflubenzuron
28) Tau-fluvalinate and Flufenoxuron
29) Tau-fluvalinate and Lufenuron
30) Tau-fluvalinate and Teflubenzuron
31) Tau-fluvalinate and Chlorfluazuron
32) Tau-fluvalinate and Spidoxamat
33) Tau-fluvalinate and Spirodiclofen
34) Tau-fluvalinate and Spiromesifen
35) Tau-fluvalinate and Beauveria spp
36) Tau-fluvalinate and Metarhizium spp
37) Tau-fluvalinate and Paecilomyces spp
38) Tau-fluvalinate and Cydia pomonella GV
39) Tau-fluvalinate and Thaumatotibia leucotreta GV
40) Tau-fluvalinate and Thaumatotibia leucotreta GV
41) Tau-fluvalinate and Anticarsia gemmatalis MNPV
42) Tau-fluvalinate and Helicoverpa armigera NPV
43) Tau-fluvalinate and Flometoquin
44) Tau-fluvalinate and Buprofezin
45) Tau-fluvalinate and Chromafenozide
46) Tau-fluvalinate and Halofenozide
47) Tau-fluvalinate and Methoxyfenozide
48) Tau-fluvalinate and Tebufenozide
49) Tau-fluvalinate and Acequinocyl
50) Tau-fluvalinate and Fluacrypyrim
51) Tau-fluvalinate and Hydramethylnon
52) Tau-fluvalinate and Clotoria Ternatea
53) Tau-fluvalinate and GS-omega/kappa HXTX-Hv1a peptide
54) Tau-fluvalinate and Acynonapyr
55) Tau-fluvalinate and N-octyl bicycloheptene dicarboximide (MGK-264)
56) Tau-fluvalinate and Piprotal
57) Tau-fluvalinate and Propyl isome
58) Tau-fluvalinate and Sesamex
59) Tau-fluvalinate and Sesamolin
60) Tau-fluvalinate and Sulfoxide
61) Tau-fluvalinate and Pydiflumetofen
62) Tau-fluvalinate and Fluazinam
63) Tau-fluvalinate and Fluxapyroxad
64) Tau-fluvalinate and Difenoconazole
65) Tau-fluvalinate and Tebuconazole
66) Tau-fluvalinate and Fludioxonil
67) Tau-fluvalinate and Azoxystrobin
68) Tau-fluvalinate and Mancozeb
69) Tau-fluvalinate and Cycloxaprid
70) Tau-fluvalinate and Guadipyr
71) Tau-fluvalinate and Imidaclothiz
72) Tau-fluvalinate and Cyflumetofen
73) Tau-fluvalinate and Sila-Cyflumetofen
74) Tau-fluvalinate and Cyproflanilide
75) Tau-fluvalinate and Dicloromezotiaz
76) Tau-fluvalinate and Fenmezoditiaz
77) Tau-fluvalinate and Dimpropyridaz
78) Tau-fluvalinate and Tyclopyrazoflor
79) Tau-fluvalinate and Fluchlordiniliprole
80) Tau-fluvalinate and Fluazaindolizine
81) Tau-fluvalinate and Flufiprole
82) Tau-fluvalinate and Nicofluprole
83) Tau-fluvalinate and Pyriprole
84) Tau-fluvalinate and Fluhexafon
85) Tau-fluvalinate and Bistrifluron
86) Tau-fluvalinate and Trifluenfuronate
87) Tau-fluvalinate and Lotilaner
88) Tau-fluvalinate and Indazapyroxamet
89) Tau-fluvalinate and Mineral oil which includes paraffinic oils
90) Tau-fluvalinate and Garlic extract
91) Tau-fluvalinate and Neem extract
92) Tau-fluvalinate and Tea tree oil
93) Tau-fluvalinate and Clove oil
94) Tau-fluvalinate and Citronella oil
95) Tau-fluvalinate and Rose oil
96) Tau-fluvalinate and Palmarosa oil
97) Tau-fluvalinate and Geraniol
98) Tau-fluvalinate and Thymol
99) Tau-fluvalinate and one or more agrochemically acceptable additives selected from a group
comprising Diatomaceous earth, Amorphous silica, Hydroxylpropyl methylcellulose, Kaolin
(calcined), Polydimethylsiloxane and Potassium salts of fatty acids.

5. The mixture combination of any one of claims 1-4, wherein the mixture exhibits synergistic effects.

6. The mixture combination of any one of claims 1-5, wherein the weight ratio of Tau fluvalinate and the Nicotinic acetylcholine receptor (nAChR) competitive modulator is from 1:50 to 50:1.

7. The mixture combination of claim 6, wherein the weight ratio of Tau fluvalinate and Flupyrimin is from 1:50 to 50:1.

8. The mixture combination of claim 7, wherein the weight ratio of Tau fluvalinate and Flupyrimin is from 1:10 to 10:1.

9. The mixture combination of any one of claims 1-5, wherein the weight ratio of Tau fluvalinate and the meta-diamide insecticide is from 1:50 to 50:1.

10. The mixture combination of claim 9, wherein the weight ratio of Tau fluvalinate and Isocycloseram is from 1:50 to 50:1.

11. The mixture combination of claim 10, wherein the weight ratio of Tau fluvalinate and Isocycloseram is from 1:1 to 5:1.

12. The mixture combination of any one of claims 1-5, wherein the weight ratio of Tau fluvalinate and the Ecdysone receptor agonist is from 1:50 to 50:1.

13. The mixture combination of claim 12, wherein the weight ratio of Tau fluvalinate and Methoxyfenozide is from 1:50 to 50:1.

14. The mixture combination of claim 13, wherein the weight ratio of Tau fluvalinate and Methoxyfenozide is from 1:1 to 5:1.

15. The mixture combination of any one of claims 1-5, wherein the weight ratio of Tau fluvalinate and the plant extract is from 1:50 to 50:1.

16. The mixture combination of claim 15, wherein the weight ratio of Tau fluvalinate and Garlic extract is 1:1.

17. The mixture combination of any one of claims 1-16, wherein the application rates of the mixture according to the invention are from 1 g/ha to 1000 g/ha.

18. A pesticidal composition comprising: (i) the mixture combination of any one of claims 1-17; and (ii) an agriculturally acceptable carrier.

19. The pesticidal composition of claim 18, further comprising at least one surfactant, solid diluent, liquid diluent, or a combination thereof.

20. A method for controlling insects comprising contacting the insect or their food supply, habitat, breeding grounds or their locus with an effective amount of the mixture combination of any one of claims 1-17 or the composition of claim 18 or 19 so as to thereby control insects.

21. The method for controlling insects according to claim 20, wherein the insects are selected from a group comprising Spidermites, Halotydeus spp. Tetranychus urticae, Spodoptera littoralis, Spodoptera spp, Helicoverpa spp., Aphis spp., Myzus spp., Bemisia tabaci, Trialurodes vaporariorum, Tuta absoluta, Halyomorpha halys, Drosophila spp., Frankliniella spp., Aphis gossypii, Tetranichus spp., Lygus spp., Bactrocera dorsalis, B. tryoni, Ceratitis spp., Ceratitis capitata, Bactericera cockerelli, Nysius spp, Nilaparvata lugens, Ectomyelois ceratoniae, Amyelosis transitella, C. auricilius, Chilo spp., Cnaphalocerus medinalis, Cydia pomonella, S. innotata, Scirpophaga incertulas, Eriococcus spp, Ulonemia spp, Heliothrips haemorrhaidalis, Selenothrips spp and Chaetanaphothrips spp.

22. The method of claim 21 for controlling the insect, Bemisia tabaci by contacting the insect or their food supply, habitat, breeding grounds or their locus with an effective amount of the mixture combination of any one of claims 1-17, in a weight ratio from 1:100 to 100:1, so as to thereby controlling the said insect.

23. The method of claim 22 for controlling the insect, Bemisia tabaci by contacting the insect or their food supply, habitat, breeding grounds or their locus with an effective amount of the mixture of Tau fluvalinate and a Nicotinic acetylcholine receptor (nAChR) competitive modulator, as defined in claim 1, in a weight ratio from 1:100 to 100:1, so as to thereby controlling the said insect.

24. The method of claim 23 for controlling the insect, Bemisia tabaci by contacting the insect or their food supply, habitat, breeding grounds or their locus with an effective amount of the mixture of Tau fluvalinate and Flupyrimin, in a weight ratio from 1:100 to 100:1, so as to thereby controlling the said insect.

25. The method of claim 22 for controlling the insect, Bemisia tabaci by contacting the insect or their food supply, habitat, breeding grounds or their locus with an effective amount of the mixture of Tau fluvalinate and a meta-diamide insecticide, as defined in claim 1, in a weight ratio from 1:100 to 100:1, so as to thereby controlling the said insect.

26. The method of claim 25 for controlling the insect, Bemisia tabaci by contacting the insect or their food supply, habitat, breeding grounds or their locus with an effective amount of the mixture of Tau fluvalinate and Isocycloseram, in a weight ratio from 1:100 to 100:1, so as to thereby controlling the said insect.

27. The method of claim 22 for controlling the insect, Bemisia tabaci by contacting the insect or their food supply, habitat, breeding grounds or their locus with an effective amount of the mixture of Tau fluvalinate and a plant extract, as defined in claim 1, in a weight ratio from 1:100 to 100:1, so as to thereby controlling the said insect.

28. The method of claim 27 for controlling the insect, Bemisia tabaci by contacting the insect or their food supply, habitat, breeding grounds or their locus with an effective amount of the mixture of Tau fluvalinate and Garlic extract, in a weight ratio from 1:100 to 100:1, so as to thereby controlling the said insect.

29. The method of claim 21 for controlling the insect, Spodoptera littoralis by contacting the insect or their food supply, habitat, breeding grounds or their locus with an effective amount of the mixture combination of any one of claims 1-17, in a weight ratio from 1:100 to 100:1, so as to thereby controlling the said insect.

30. The method of claim 29 for controlling the insect, Spodoptera littoralis by contacting the insect or their food supply, habitat, breeding grounds or their locus with an effective amount of the mixture of Tau fluvalinate and a Nicotinic acetylcholine receptor (nAChR) competitive modulator, as defined in claim 1, in a weight ratio from 1:100 to 100:1, so as to thereby controlling the said insect.

31. The method of claim 30 for controlling the insect, Spodoptera littoralis by contacting the insect or their food supply, habitat, breeding grounds or their locus with an effective amount of the mixture of Tau fluvalinate and Flupyrimin, in a weight ratio from 1:100 to 100:1, so as to thereby controlling the said insect.

32. The method of claim 29 for controlling the insect, Spodoptera littoralis by contacting the insect or their food supply, habitat, breeding grounds or their locus with an effective amount of the mixture of Tau fluvalinate and an Ecdysone receptor agonist, as defined in claim 1, in a weight ratio from 1:100 to 100:1, so as to thereby controlling the said insect.

33. The method of claim 32 for controlling the insect, Spodoptera littoralis by contacting the insect or their food supply, habitat, breeding grounds or their locus with an effective amount of the mixture of Tau fluvalinate and Methoxyfenozide, in a weight ratio from 1:100 to 100:1, so as to thereby controlling the said insect.

34. The method of claim 29 for controlling the insect, Spodoptera littoralis by contacting the insect or their food supply, habitat, breeding grounds or their locus with an effective amount of the mixture of Tau fluvalinate and a meta-diamide insecticide, as defined in claim 1, in a weight ratio from 1:100 to 100:1, so as to thereby controlling the said insect.

35. The method of claim 34 for controlling the insect, Spodoptera littoralis by contacting the insect or their food supply, habitat, breeding grounds or their locus with an effective amount of the mixture of Tau fluvalinate and Isocycloseram, in a weight ratio from 1:100 to 100:1, so as to thereby controlling the said insect.

36. A method for protecting plants from attack or infestation by insects comprising contacting the plant, or the soil or water in which the plant is growing, with an effective amount of the mixture of any one of claims 1-17 or the composition of claim 18 or 19 so as to thereby protect plants from attack or infestation by insects.

37. A method for enhancing knock-down activity and/or prolonged control comprising contacting the plant, or the soil or water in which the plant is growing, with an effective amount of the mixture of any one of claims 1-17 or the composition of any one of claim 18 or 19 so as to thereby enhance knock-down activity and/or prolonged control.

38. A method for enhancing plant development comprising applying to the plant, a locus of the plant and/or propagation material of the plant an effective amount of the mixture of any one of claims 1-17 or the composition of claim 18 or 19 so as to thereby enhance plant development.

39. A method for regulating plant growth comprising applying to the plant, a locus of the plant and/or propagation material of the plant an effective amount of the mixture of any one of claims 1-17 or the composition of claim 18 or 19 so as to thereby regulate plant growth.
